(19) United States
(12) Patent Application Publication
(10) Pub. No.: US 2025/0054354 A1
(43) Pub. Date: Feb. 13, 2025

(54) EMBEDDED FEATURE ELECTRONIC PULL-TAB SYSTEM AND METHOD

(71) Applicant: Pilot Gaming Systems, Inc., Reno, NV (US)

(72) Inventors: Jon Weaver, Birmingham, MI (US); Anthony M. Morelli, Mt. Pleasant, SC (US)

(21) Appl. No.: 18/764,704

(22) Filed: Jul. 5, 2024

Related U.S. Application Data
(60) Provisional application No. 63/525,593, filed on Jul. 7, 2023.

(51) Int. Cl. G07F 17/32

(52) U.S. Cl. CPC G07F 17/3213; G07F 17/329

(57) ABSTRACT

A pull-tab gaming system and method are described. The pull-tab gaming system includes a network component and a gaming device. The network component generates an electronic pull-tab deck including a plurality of electronic pull-tab tickets. Each electronic pull-tab ticket is associated with a ticket value, a pre-reveal value, and a display area. The gaming device generates an electronic pull-tab ticket request and communicates the request to the network component. The network component selects one electronic pull-tab ticket and transmits that ticket to the gaming device. The gaming device displays an image associated with the electronic pull-tab ticket at the display area. The gaming device performs a screen shift action when the pre-reveal value is a non-zero value. The screen shift action performed corresponds to the electronic pull-tab ticket pre-reveal value that includes reveal of at least one game symbol.

### CROSS-REFERENCES

This patent application claims the benefit of provisional patent application 63/525,593 entitled EMBEDDED FEATURE ELECTRONIC PULL-TAB SYSTEM AND METHOD, filed on Jul. 7, 2023; and the above patent application is hereby incorporated by reference in this patent application.

### FIELD

A system and method for providing embedded feature electronic pull-tab game sessions are described. More particularly, the embedded feature electronic pull-tabs include embedded pre-reveal features that are visible prior, during, and after the game session, and may be presented to the player prior, during, and after the game session.

### BACKGROUND

Typical wagering devices include slot machines and video lottery terminals and are normally managed by various types of computer systems which monitor and control their activities. Such wagering devices are typically located in casinos, racetracks, tribal gaming locations, fraternal organizations, lottery outlets or other authorized locations. These are generally capital-intensive operations requiring a significant capital expenditure.

Wagering system have been developed where a central computer system is interconnected via one or more of a variety of communication mechanisms to venues where wagering devices, such as VLTs or slot machines, allow players to play via the insertion of cash or equivalent into the machines. The information associated with the wagering devices is transmitted to the central computer, which provides security monitoring and accounting services. Many varieties of such systems exist.

The wagering devices may operate as stand-alone wagering devices, in which the wagering activity and prize awards are handled principally by the retail device, e.g., slot machine, and the central system is tasked with monitoring and reporting activities associated with the retail device. Other stand-alone wagering devices are more highly integrated with the central system, in which the central system performs some or all the game play and the retail device reflects the wagering results determined by the central system.

Typically, the traditional wagering devices in the retail venues are proprietary devices that incorporate coin and or currency accepting devices. In some instances, the wagering devices may include credit or debit card readers, although that is prohibited by law and/or regulation in many jurisdictions.

More recently, central systems have been developed that use commercial digital tablets or similar mobile devices that are configured and operated at a particular venue. These mobile devices do not have coin or currency readers. Instead, the mobile devices operate in conjunction with a cashier operated point-of-sale (POS) device, or a kiosk. In operation, a cashier will accept funds from a person that desires to use an application on the tablet and the cashier uses functions on the POS device to fund a temporary account that is tied to a particular venue's mobile device; the mobile device is then loaned to the user. In some jurisdictions systems exist that allow personal mobile devices, e.g., smartphones, to be used as a wagering device that operates wagering games in various online configurations.

While these centralized systems provide players greater flexibility as to when and how they play traditional casino and charity games, the fundamental game mechanics the players experience have not changed.

Because there is continuing competition for players' attention from different game animations, volatility, location flexibility, there is a continuing need to provide new interesting gaming opportunities, such as new and interesting gaming mechanics.

### SUMMARY

A pull-tab gaming system and method are described. The pull-tab gaming system includes a network component and a gaming device. The gaming device is communicatively coupled to the network component and includes a processor, a memory, and a display. The network component generates an electronic pull-tab deck having electronic pull-tab tickets. Each of the electronic pull-tab tickets is associated with a ticket value, a pre-reveal value, and a display area. A plurality of game symbol display positions is associated with the display area.

An electronic pull-tab ticket request is received by one of the plurality of gaming devices, and then the electronic pull-tab request is communicated to the network component, which selects one electronic pull-tab ticket. The gaming device receives the selected electronic pull-tab ticket from the network component and displays an image associated with the electronic pull-tab ticket at the display area.

The gaming device performs a screen shift action when the screen shift value associated with the electronic pull-tab ticket is a non-zero value. The screen shift action performed corresponds to the non-zero pre-reveal value associated with the selected electronic pull-tab ticket. The screen shift action includes the reveal of at least one game symbol.

In one embodiment, the screen shift action includes a zoom-in action, a pan action, a rotate action, or any combination thereof.

In one embodiment, the screen shift action includes revealing at least three game symbols. In one embodiment, the screen shift action includes an animation.

In one embodiment, the network component awards the ticket value to a player account.

In one embodiment, at least one game symbol includes a prize multiplier.

In one embodiment, the network component includes a centralized resource server and a deck generator. In this embodiment, the centralized resource server selects the electronic pull-tab ticket and the deck generator server generates the deck that includes the plurality of electronic pull-tab tickets.

In the pull-tab gaming method, a network component generates an electronic pull-tab deck that includes a plurality of electronic pull-tab tickets that are each associated with a ticket value, a screen shift value, and a display area. A plurality of game symbol display positions are associated with the display area. A gaming device is communicatively coupled to the network component, and the gaming device includes a processor, a memory, and a display. The method proceeds when the gaming device generates an electronic pull-tab ticket request. The gaming device then communicates the electronic pull-tab ticket request to the network component. The network component then selects one electronic pull-tab ticket. The gaming device then receives the selected electronic pull-tab ticket from the network component and displays an image associated with the electronic pull-tab ticket at the display area. The gaming device then performs a screen shift action when the screen shift value associated with the electronic pull-tab ticket is a non-zero value. The screen shift action performed corresponds to the non-zero pre-reveal value associated with the electronic pull-tab ticket, and that screen shift action includes reveal of at least one game symbol.

### BRIEF DESCRIPTION OF THE DRAWINGS

The present invention will be more fully understood by reference to the following drawings which are presented for illustrative, not limiting, purposes.

FIG. 1 shows an illustrative centralized gaming system.

FIG. 2 shows an illustrative authorized mobile device or point-of-sale device.

FIG. 3 shows detail of the mobile wagering sub-system.

FIG. 4 shows an illustrative point-of-sale (POS) device communicatively coupled to authorized mobile devices in a gaming venue.

FIG. 5 shows an illustrative Video Presentation System.

FIG. 6 shows a more detailed view of an illustrative video presentation sub-system (VPS) client.

FIGS. 7A and 7B show an embedded feature electronic pull-tab ticket gaming method that describes the various steps performed by a player interacting with the gaming system.

FIGS. 8A-C show gameplay for game symbol reveal animations for an embedded feature electronic pull-tab ticket game.

FIGS. 9A and 9B show embedded feature gameplay animations for an embedded feature electronic pull-tab ticket game.

FIG. 10 shows an embedded pre-reveal symbol reveal for an embedded feature electronic pull-tab ticket game.

FIGS. 11A and 11B show final symbol reveals for an embedded feature electronic pull-tab ticket game.

FIGS. 12A and 12B show initial game screen displays for a pick-em embedded feature electronic pull-tab ticket game.

FIGS. 13A and 13B show game screen displays of a first pick-em symbol selection and reveal for a pick-em embedded feature electronic pull-tab ticket game.

FIGS. 14A-C show game screen displays of a second pick-em symbol selection and pre-reveal animation for a pick-em embedded feature electronic pull-tab ticket game.

FIGS. 15A-C show game screen displays of a third pick-em symbol selection and pre-reveal animation for a pick-em embedded feature electronic pull-tab ticket game.

FIGS. 16A and 16B show final and award game screen displays for a pick-em embedded feature electronic pull-tab ticket game.

FIGS. 17A and 17B show a flowchart for an embedded feature gaming method presenting a pre-reveal animation prior to reveal of any game symbols.

FIGS. 18A and 18B show a flowchart for an embedded feature gaming method presenting a pre-reveal animation after the reveal of at least one game symbol and prior to reveal of a final game symbol(s).

FIGS. 19A and 19B show a flowchart for an embedded feature gaming method presenting a pre-reveal animation after the reveal of all game symbols.

FIGS. 20A and 20B show a flowchart for an embedded feature gaming method presenting a pick-em pre-reveal feature.

### DETAILED DESCRIPTION

Persons of ordinary skill in the art will realize that the following description is illustrative and not in any way limiting. Other embodiments of the claimed subject matter will readily suggest themselves to such skilled persons having the benefit of this disclosure. The various illustrative embodiments will now be described more fully with reference to the accompanying drawings. It should be understood that this disclosure and the claims may be embodied in many different forms and should not be construed as limited to the embodiments set forth herein. Additionally, those familiar with computing systems shall appreciate that there are many variants possible for the described systems, depending on the nature of the available networks, legal frameworks, which can open or restrict the types of locations in which the system can be operated, advances in server and networking technologies, etc.

The gaming systems and methods presented herein include a mobile wagering and entertainment system that is designed to be used in wagering applications within legal gaming frameworks. More specifically, the gaming systems and methods presented herein support centralized control of embedded feature electronic pull-tab ticket wagering that takes place in multiple wagering venues and provides an integrated broadcast capability so that an entertaining complement to the wagering can be presented on television screens in the gaming venues.

A gaming venue includes a charity, a casino and any other such authorized or licensed gaming venue. Additionally, a gaming venue includes a church, hotel, bar, restaurant, convenience store and other such locations that support licensed gaming activity. Note, that the term “gaming” refers to games of chance or games that include a chance component, in which a wager is received and the awarded prize is dependent on the outcome of the game of chance or of the chance component.

As described in further detail herein, the gaming system and method includes a Mobile Wagering Sub-system (MWS), a Video Presentation Sub-system (VPS), and embedded feature electronic pull-tab tickets. The gaming system is communicatively coupled to a plurality of remote gaming venues, in which each remote gaming venue has at least one mobile client device that supports customer wagering. Additionally, each remote gaming venue may include one or more Point-of-Sale stations that manage player funds. Furthermore, each remote gaming venue may include one or more television monitors that broadcast content complementary to wagering activities. In the illustrative embodiments presented herein, the various elements of the gaming system are communicatively and operatively coupled to one another with a network structure that includes the Internet as the backbone and at least one secure Wi-Fi network within each gaming venue.

The centralized gaming system provides embedded feature electronic game sessions that include pre-reveal features that are immediately visible in the background of the game. In some embodiments, these embedded pre-reveal features may be presented to players prior to initiation of the game. In some embodiments, these embedded pre-reveal feature may interrupt the game session and be presented to players prior after initiation and prior to completion of the game session. In some embodiments, these embedded pre-reveal features are presented to players after completion of the game session.

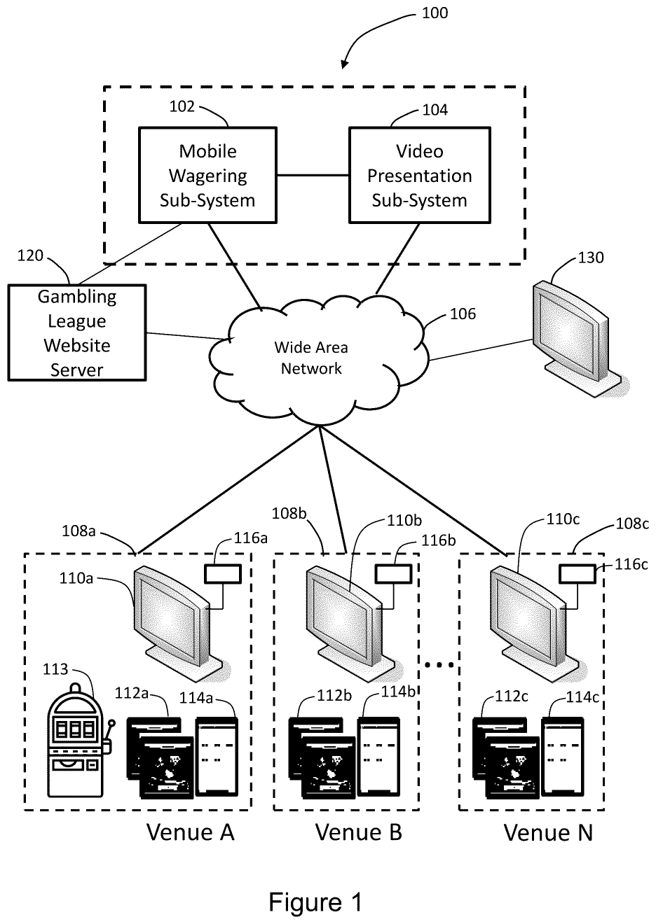

Referring to FIG. 1, there is shown an illustrative centralized gaming system. The centralized gaming system 100 includes a mobile wagering sub-system 102 and a video presentation sub-system 104. The mobile wagering sub-system 102 and the video presentation sub-system 104 are communicatively coupled to one another. Additionally, the mobile wagering sub-system 102 and the video presentation sub-system 104 are communicatively coupled to a Wide Area Network 106, e.g. Internet, which is communicatively coupled to a plurality of gaming venues, namely, gaming illustrative Venue A 108a, Venue B 108b and other such gaming venues as represented by Venue N 108c. Each of the plurality of gaming venues 108a, 108b and 108c include a stationary monitor 110a, 110b and 110c, respectively. Each stationary monitor 110a, 110b and 110c is communicatively coupled to the video presentation client 116a, 116b and 116c, respectively. The video presentation clients 116 are also communicatively coupled to the video presentation subsystem 104. The combination of the stationary monitor 110 and the video presentation client 116 may also be referred as a “stationary monitor client,” and as such reference to “stationary monitor client” refers to the combination of the stationary monitor 110 and the video presentation client 116.

Within the system architecture each gaming venue may be associated with a sponsoring organization, e.g. a charity, and an additional business entity, e.g. a distributor. The types of venues, sponsoring organizations and other business entities will vary according jurisdictional statures and regulation.

Additionally, each of the gaming venues 108a, 108b and 108c include a plurality of authorized mobile devices 112a, 112b and 112c, respectively. Further still, each of the gaming venues includes a Point-of-Sale (POS) device 114a, 114b and 114c. The illustrative authorized mobile devices 112 and the POS devices 114 are client devices configured to communicate with each other and the mobile wagering subsystem 102. In operation, the authorized mobile devices 112 and POS devices 114 are registered with the mobile wagering sub-system 102, which includes a database (not shown) that associates the authorized mobile devices 112 and POS devices 114 with a designated gaming venue 108. Thus, authorized mobile devices 112 and POS devices 114 are not allowed to interact with the centralized gamine system 100 when the client devices are not located at the designated gaming venue.

The illustrative authorized mobile devices 112 operate as wireless client devices that are communicatively coupled to the centralized gaming system 100. Additionally, the centralized gaming system 100 may be communicatively coupled to authorized non-mobile clients. Furthermore, other client devices such as non-mobile clients may be disposed in the gaming venues and these non-mobile clients may be communicatively coupled to the centralized gaming system 100. These authorized non-mobile client devices include, but are not limited to, wired devices such as gaming machines, slot machines, PCs, stationary monitors, Internet appliances, Internet of Things (IoT) devices and other such non-mobile devices with hardwire connections or wireless connections to the Wide Area Network 106. The non-mobile client devices may be configured to participate in the games presented herein including, but not limited to, the tournament games described hereinafter.

Operationally, client devices must comply with the system-centric gaming requirements in which all gaming and accounting activity are controlled by the mobile wagering sub-system 102 servers, and have the communications infrastructure, directly or by proxy, to interact with the server in a manner consistent with the operations of the authorized mobile devices 112 described herein.

The illustrative gaming system 100 includes a plurality of server applications that are configured to provide high-availability and redundancy, process all inputs and generates outputs. The illustrative gaming system 100 includes three different types of network communications. Firstly, there are network communications between the internal server components, namely, the mobile wagering sub-system 102 and the video presentation sub-system 104. Secondly, there are network communications between the server components, e.g. the mobile wagering sub-system 102 and the video presentation sub-system 104, and the remote gaming venues 108a, 108b and 108c, as well as the Gambling League Website server 120. Thirdly, there are network communications within the gaming venues 108a, 108b, and 108c.

With respect to network communications between the internal server components, the illustrative server components operate as a single network, in which the servers can communicate with one another using service requests. By way of example and not of limitation, the illustrative internal server components have two internet protocol addresses, namely, a Private IP used to maintain the server network and ensuring secure server-to-server communication, and a Public IP that is bound to the Internet and that provides access to server services through high security communications such as HTTPS. The internal server components use their private IPs for server-to-server communication so that these services are not exposed to the Internet, the game application running on the authorized mobile devices and the POS devices.

By way of example and not of limitation, each server is configured with an SSL certificate which supports HTTPS calls. The illustrative server is configured to forward some requests it receives through HTTPS to a local port, and the requests that are allowed to pass are only those available to authorized “Game” and “POS” devices. This illustrative configuration ensures that only very specific requests are allowed from the public IP.

By way of example and not of limitation the servers are implemented using the Linux operating system using Restful programming techniques using Java as the programming language with Jersey RS support. Database structures are contained in a MySQL database.

Communication between the server components, namely, the mobile wagering sub-system 102 and the video presentation sub-system 104, and the remote client devices is performed over a wide-area network 106. As described above, these network communications are performed using secure SSL communications over the Internet.

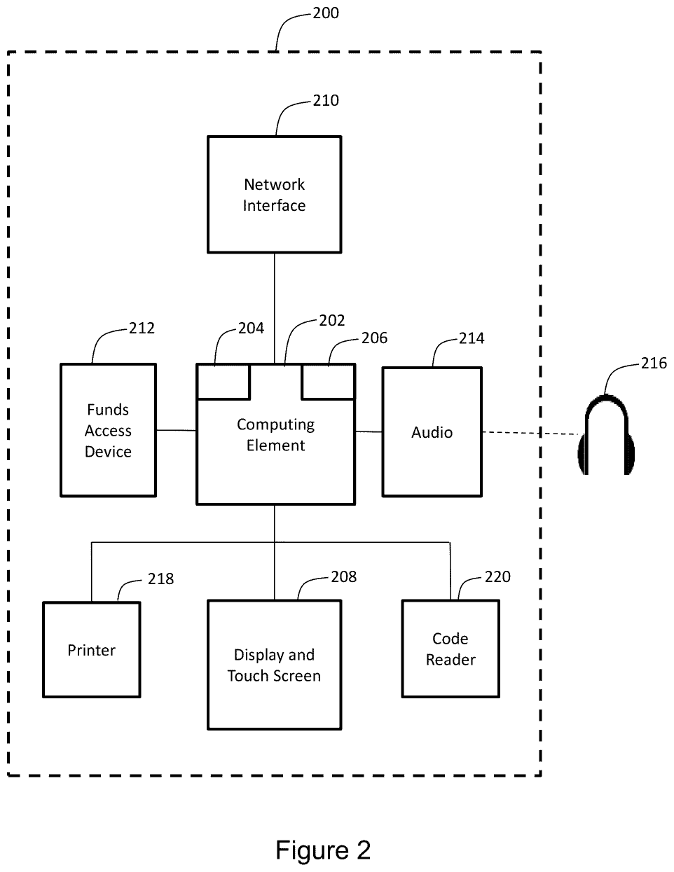

The authorized mobile devices 112a, 112b and 112c are also referred to as a “player interface unit.” An illustrative authorized mobile device is presented in FIG. 2. Operationally, each authorized mobile device 112 in an illustrative embodiment is associated with a player account.

By way of example and not of limitation, the player account is described as a short-term, anonymous entity tied to the client device being used by the player, and which expires when the fund balance drops to zero. However, it is possible in other embodiments to have player accounts which may exist for longer time periods and be tied to a player.

Additionally, it should be noted that while the illustrative embodiments presented herein generally describe financial transactions such as adding funds or cashing out at the POS device 114, in different regulatory environments or with different technology, such player accounts can have financial transactions originating at the player device or any other client device that may be configured to support POS transaction. Also, the financial transactions may be supported at a system level with a server component or server module that provides a web portal functions for financial transactions. Thus, the financial transactions may be performed by the client device, a server component, a server module, or any combination thereof. Depending on regulatory issues and available technology, financial transactions may be based on cash, credit cards, debit cards, digital currency or other mediums of finance.

Referring now to FIG. 2, there is shown an illustrative player interface unit 200. The player interface unit 200 can comprise the authorized mobile device 112, the point-of-sale device 114, and any combination thereof. For example, the illustrative player interface unit 200 may be one of the plurality of authorized mobile devices 112 that are associated with each venue. The illustrative player interface unit 200 includes a central computing element 202 with a processor 204 and memory storage 206. One or more games may be pre-installed on the player interface unit 200 before the player interface units are deployed in a gaming venue or other such production environment. Alternatively, the illustrate game title files may be stored in a remote server, e.g. an “App” store, and the player interface unit 200 may be configured to download the game title file, run the game title file and enable the user to interact with the corresponding game title.

The player interface unit 200 also includes a color display with a touch-screen 208 and a network interface component 210, which provides network access to a local area network, a wide area network or any combination thereof. By way of example and not of limitation the network interface component supports a wireless local area network such as a Wi-Fi network, which is based on IEEE 802.11 standards. Additionally, the player interface unit 200 may communicate with the wide area network 106 via the illustrative Wi-Fi network. The communication between the player interface unit 200 and the mobile wagering sub-system 102 may be performed using the illustrative HTTPS protocol or other such secure networking protocol that allows game session inputs, commands and outputs to be communicated securely across the Wide Area Network.

In an illustrative embodiment, the player interface unit 200 may be a tablet computing device running iOS or Android operating systems. The illustrative player interface unit may also include a Funds Access Device module 212 that may be configured to have a custom locked profile to evade security-bypassing attempts. The Funds Access Devices (FAD) 212 may also provide alternative methods for starting play sessions or adding funds to existing sessions. By way of example and not of limitation, the Funds Access Device module 212 may include currency readers and debit/credit card readers such as a magnetic stripe reader, a smart-card reader, an infra-red reader, a Near-Field-Communications reader and other such financial transaction readers.

The player interface unit 200 may also include an audio system component 214 that enhances the game-playing experience for the players. The audio system component 214 may also include a standard audio jack so that a player can use wired or wireless headphones 216 to improve the game audio environment without disturbing others.

In one illustrative embodiment, the player interface unit 200 may include a printer 218 and a code reader 220. By way of example and not of limitation, the printer 218 generates vouchers. The illustrative code reader 220 may be embodied as a bar-code reader that is configured to read vouchers generated by the printer.

By way of example and not of limitation, the player interface unit 200 may be configured to include a “HELP” button in the game client that also dispatches a signal to the POS to notify the operator that the player is requesting assistance. The player interface unit 200 may also be configured to include a text-to-speech functionality to aid a visually impaired player. Additionally, the player interface unit 200 may include a gaming application that downloads files, decompresses the downloaded files if they have been compressed, and caches all assets inside the player interface unit 200. The player interface unit 200 supports dynamic updates without the need to update the game client itself.

Referring now to FIG. 1 and FIG. 2, the mobile wagering sub-system 102 is communicatively coupled to a plurality of authorized mobile devices 112 such as illustrative player interface unit 200 presented in FIG. 2. In one illustrative embodiment, the mobile wagering sub-system 102 receives a wager input for a game session from the illustrative player interface unit 200. In another illustrative embodiment, the mobile wagering sub-system 102 receives the wager input for a game session from a plurality of authorized mobile devices 112, which may disposed at one or more venues as presented in FIG. 1.

The illustrative player interface unit 200 presents a user interface on touch screen 208 that shows a plurality of game content associated with different types of game sessions. In the illustrative embodiment, the player interface unit 200 may also accept player inputs that are associated with a game session. The game session may perform various operations as described in further detail below.

In the illustrative embodiment, the video presentation sub-system 104 is communicatively coupled to the mobile wagering sub-system 102, the video presentation client 116, and the stationary monitors 110 disposed in the different gaming revenues. The video presentation sub-system 104 generates entertainment output associated with ongoing activity in the mobile gaming system.

One or more of the stationary monitors 110 then receives the entertainment output generated by the video presentation sub-system. The stationary monitors 110a, 110b and 110c then proceed to display the entertainment output generated by the video presentation sub-system 104.

In the illustrative embodiment, a first plurality of authorized devices 112a associated with a first gaming venue 108a includes a first stationary monitor 110a and first video presentation client 116a. Additionally, a second plurality of authorized mobile devices 112b associated with a second gaming venue 108b includes a second stationary monitor 110b and second video presentation client 116b. The first stationary monitor 110a and the second stationary monitor 110 are both communicatively coupled to video presentation sub-system 104. The video presentation sub-system 104 may have stored thereon an entertainment output, such as a video, that is associated with wagering activity. The video presentation sub-system 104 communicates the output, e.g. video, to the first stationary monitor 110a and the second stationary monitor 110b via the video presentation client 116a and 116b, respectively.

By way of example and not of limitation, for an illustrative bingo tournament game that includes a bingo game session, the various stationary monitors 110a, 110b and 110c may present a bingo video related to the bingo tournament game. Thus, a plurality of different authorized mobile devices 112 from different gaming venues 108 can participate in the bingo tournament game and share a similar video experience.

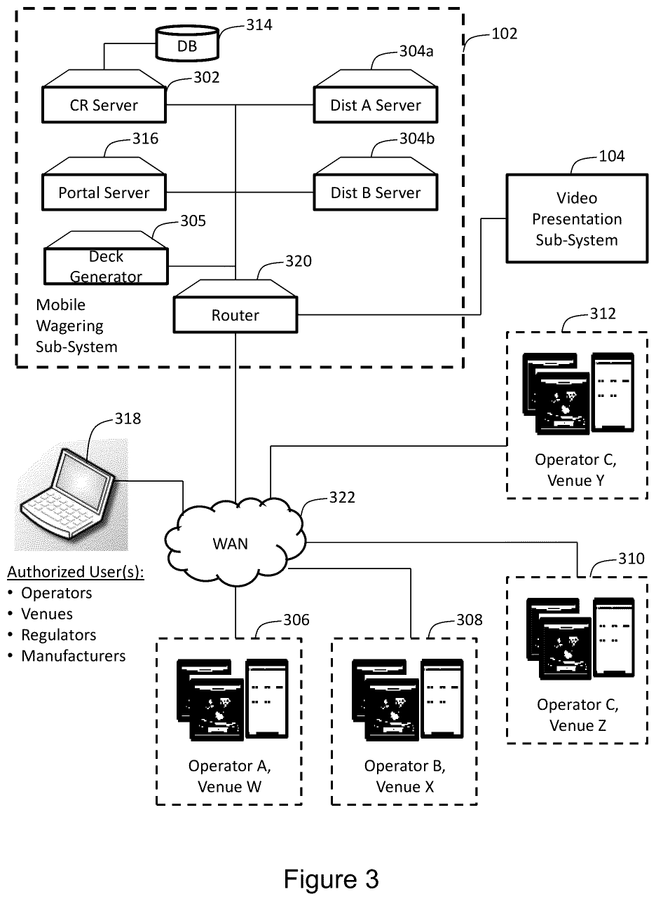

Referring to FIG. 3, there is shown further detail for the mobile wagering sub-system 102 communicatively coupled to different venues. In an illustrative embodiment, the mobile wagering system functionality is distributed on multiple servers, including those that provide database 314 functionality. The illustrative mobile wagering sub-system 102 includes a centralized resource server 302 or centralized manufacturer server that performs as a coordinating entity for system operation and maintains authority over game operations controlled by the centralized gaming system 100. The mobile wagering sub-system 102 also includes a distributor server 304 that is communicatively coupled to the centralized resource server 302.

In the illustrative embodiment presented in FIG. 3, a first distributor server 304a and second distributor server 304b are also communicatively to the centralized resource server 302. Each of the illustrative distributor servers is configured to manage and control the game operations and cashier operations performed at a set of gaming venues that are associated with a distributor who is responsible for sales and support of a multiplicity of venues.

For example, a first set of gaming venues 306 and 308 are configured to communicate with first distributor server 304a, which manages and controls the game operations at gaming venues 306 and 308. Additionally, for a second set of gaming venues 310 and 312 are configured to communicate with the illustrative second distributor server 304b manages and controls the game operations at gaming venues 310 and 312. Thus, multiple gaming venues may require additional distributor servers.

A variety of tasks may be performed by the centralized resource server 302. For example, one of the tasks performed by the centralized resource server 302 includes providing a central routing operation for each of the authorized mobile devices 112 so that each authorized mobile device 112 is routed to the proper distributor server 304a or 304b upon activation of each authorized mobile device. By way of example and not of limitation, the first request generated by a player interface unit 200 may direct the player interface unit 200 to an illustrative distributor of the player interface unit 200.

Additionally, the centralized resource server 302 may be configured to provide a central routing operation for cashier authentication. Thus, a cashier device may be authenticated by the appropriate distributor server 304, which may then forward an authentication to an illustrative mobile device distributor.

The centralized resource server 302 may also be configured to operate as a central authority for generation of finite decks of predetermined electronic pull-tab results, including embedded feature electronic pull-tab decks and their associated results. In some embodiments, the mobile wagering sub-system 102 further includes a separate deck generator server 305 that operates as the central authority for generation of finite pool decks of predetermined electronic pull-tab results, including the embedded feature electronic pull-tab decks and their associated results. In these embodiments, the deck generator server 305 is communicatively coupled to one or more of the distributor servers 304a and 304b, as well as to the centralized resource server 302, and the deck generator server 305 both randomizes the decks of electronic pull-tabs and distributes the randomized tickets from the decks.

In another illustrative embodiment, a separate system (not shown) may be responsible for generation of one or more finite decks, in which a distributor server (not shown) or centralized resource server (not shown) may communicate with a deck generator server (not shown) to randomize finite pool decks.

Furthermore, the centralized resource server 302 may be configured to manage and control financial information. The centralized resource server 302 may include a centralized database 314 that stores data generated by the cashiers, authorized mobile devices, and the various gaming venues. The centralized database 314 provides a central repository for accounting data, game play data, system configuration data, and other such data types.

The illustrative distributor servers 304 are communicatively coupled to the centralized resource server 302. Each of the distributor servers 304 may be configured to manage finances for the player accounts that are associated with the authorized mobile devices. Additionally, the illustrative distributor servers 304 may be responsible for generating logs and reports required for the POS devices. Furthermore, the illustrative distributor servers 304 may be configured to manage game play operations, wagers and prizes. Further still, the illustrative distributor servers 304 may manage cashier operations including customer sales and redemptions. Further yet, the distributor servers 304 may be configured to maintain the financial status for the authorized mobile devices, including the actual credit balance on each player device.

In an alternative embodiment, the operations performed by the centralized resource server 302 and the distributor server 304 may be performed by a centralized resource software module (not shown) and a distributor software module (not shown) that may be associated with a client-server architecture, a distributed architecture, a peer-to-peer architecture, a hierarchical architecture, a “cloud” architecture or any combination thereof.

The mobile wagering sub-system 102 may also include an illustrative web portal server 316. The web portal server 316 provides a web interface to access system accounting and operational data, as well as to maintain and configure the system. The web portal server 316 is configured to support creating, editing and removing entities like distributors, operators, venues, cashiers, devices, game parameters and others as required. All actions performed on the portal are logged for auditing purposes. This action log can be access on the portal itself if the user has the necessary system privilege.

Additionally, the pull-tab gaming system and method described may be embodied in a fixed slot machine style cabinet communicatively coupled to one or more servers, such as a Casino Management System (CMS), which is well known in the art. The illustrative CMS server would operate as a network component.

By way of example and not of limitation, the web portal server may be accessed from personal computers or tablet devices 318 over the internet. Authorized users having “administrator” privileges may access system reports and controls based upon their operational needs and organizational affiliation. The web portal server 316 supports a variety of different authorized users having different roles with different levels of access to the mobile wagering sub-system 102. For example, the web portal server may be configured to support the following roles: regulator, manufacturer, distributor with access to multiple operators, operator with access to multiple venues, a particular venue, a particular cashier and other such preconfigured roles.

An illustrative router 320 is disposed within the mobile wagering sub-system 102. The router 320 is communicatively coupled to a wide area network 322, e.g. Internet, which is communicatively coupled to the various venues and authorized users. Additionally, the illustrative router 320 is communicatively coupled to the portal server 316, the video presentation sub-system 104, each distributor server 304 and the centralized resource server 302. The router 320 forwards data packets to the appropriate server, network, internet appliance, sub-system and other such destination. Additionally, the router 320 may include a firewall that supports secure communications with the mobile wagering sub-system.

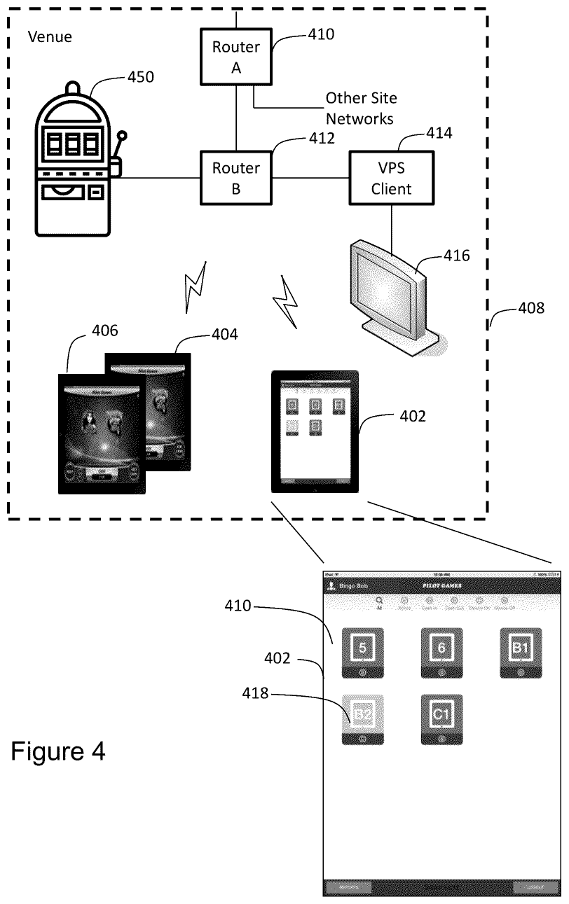

Referring now to FIG. 4, there is shown an illustrative point-of-sale (POS) device communicatively coupled to authorized mobile devices in a gaming venue. The illustrative POS device 402 is communicatively coupled to one or more authorized mobile devices 404 and 406 in gaming venue 408. By way of example and not of limitation, the illustrative POS device 402 is communicatively coupled to authorized mobile devices with a native Socket implementation inside a Local Area Network. An exploded view of an illustrative user interface 410 corresponding to POS device 402 is also shown.

The point-of-sale device 402 is configured to manage all cash operations such as cash-in operations and cash-out operations. The cash-in and cash-out operations may be requested by the authorized mobile device 404, the authorized mobile device 406, the POS 402 or any combination thereof.

The illustrative point-of-sale (POS) device 402 and authorized mobile devices 404 and 406 may be embodied as a mobile device as described above in FIG. 2. The illustrative POS device 402 is a client device configured to receive and operate an illustrative proprietary POS Application. The authorized mobile devices 404 and 406 are client devices configured to receive and operate a proprietary Game Application. The illustrative POS device 402 and authorized mobile devices 404 and 406 are communicatively coupled with the mobile wagering sub-system 102. In the illustrative embodiment, the client devices communicate with the mobile wagering sub-system 102 for each transaction. More generally, all wagering and accounting information is monitored and stored in the centralized gaming system 100 and the client devices always reflect the information received from the centralized gaming system 100. For reasons of security and consistency all game play decisions and financial data is hosted in the centralized gaming system and only visually reflected in the client devices.

As shown in FIG. 4, the illustrative wide area network 106, e.g. Internet, (shown in FIG. 1) is communicatively coupled to the illustrative gaming venue 408. In the illustrative embodiment, the illustrative wide area network terminates at Router A 410. The illustrative Router A 410 may be a pre-existing router located at the venue 408 and usable for multiple purposes, depending on the needs of the venue. For example, Router A 410 may be a component of a cable IV system. In the illustrative embodiment, a second Router B 412 is also communicatively coupled to router A 410. Illustrative Router B 412 is configured to support the requirements for communications with the mobile wagering sub-system 102 and video presentation sub-system 104.

In the illustrative embodiment, router B 412 establishes two private Wi-Fi SSIDs to be used only at a specific site. Each Wi-Fi SSID includes a security key that is unique to that site and is not available to site personnel. One SSID may be used for the exclusive use of the mobile wagering sub-system 102 and a second SSID may be provided for exclusive use of the video presentation system 104. Router B is also communicatively coupled to video presentation client 414, which is communicatively coupled to the monitor 416.

The illustrative POS 402 tablet is an electronic device that may be operated cashier in a venue. The POS device 402 provides control over financial activity within the venue. The illustrative POS Application program runs on a tablet device and supports the following illustrative operations, namely, a cash-in operation (sales), a cash-out operation (redemption) and a reporting operation.

In the illustrative embodiment, the cashier logs into the POS application program by providing a cashier user name and password. During the set-up process, the cashier name is associated with a cashier role that is associated only with a particular venue. After a successful login, the POS client retrieves relevant system information from an illustrative distributor server 304, which presents the user interface 410.

The illustrative user interface 410 associated with POS client 402 presents colored icons, in which each icon represents one of the authorized mobile devices (such as authorized mobile devices 404 and 406) in the venue 408. Note that the illustrative authorized mobile devices 406 and 408 may also be referred to as “a registered gaming client.” By way of example, each icon 418 has a short identifier representing the local identification of the device, which is unique within that venue. For example, a grey icon may identify that the authorized mobile device has been registered with the mobile wagering sub-system; however, the authorized mobile device is not currently available for game play. Another illustrative icon may be a yellow icon, which represents that the authorized mobile device is present and available. A green icon may represent that the authorized mobile device has credit and is involved in a game session. A red icon may represent that a player input has been received that relates to a HELP button input command, a cash input command or a cash output command.

In operation, an illustrative cashier that is interactive with the user interface 410 may select an icon associated with a particular authorized mobile device. After selecting the appropriate authorized mobile device, the cashier may interact with another user interface that enables the cashier to add cash to the authorized mobile device, to enable a player cash-out from the authorized mobile device, to display a log of recent play and transactional activity, which may be retrieved from the illustrative centralized resource server, the distributor server or any combination thereof.

A variety of other user interfaces may also be presented in the point-of-sale device. For example, a user interface may be presented that allows the illustrative cashier to access reports and to log-out from the POS device. For example, a reports screen may be presented that summarizes the business activity of the current day, the previous day or a historical period. The reports may include data regarding cash-in sales (in dollars), awarded prizes (in US Dollars) and net revenue, which is the difference between the cash-in sales and the awarded prizes. The illustrative reports screen may be refreshed in real time or in pseudo real time.

By way of example and not of limitation, a player may interact with the centralized gaming system 100 by purchasing play credits, e.g. funds, at the POS device 402. For example, the illustrative player requests an amount of credit and pays the cashier at POS device 402. Subsequently, a POS session is established with the central database 314 (shown in FIG. 3) when the illustrative distributor server 304 receives a cash-in message from the POS client device 402. The illustrative cash-in message identifies the session amount, the identification of the authorized mobile device to which the POS session amount is linked and the identity of the POS device initiating the transaction. The distributor server 304 acknowledges that POS transaction and provides update information to the specific game client indicating the amount of available at credit. In addition, a player may elect to add credit to an existing balance by purchasing such credit from a cashier, who may use a POS ADD CASH function to record the transaction in the server database and update the available credit total.

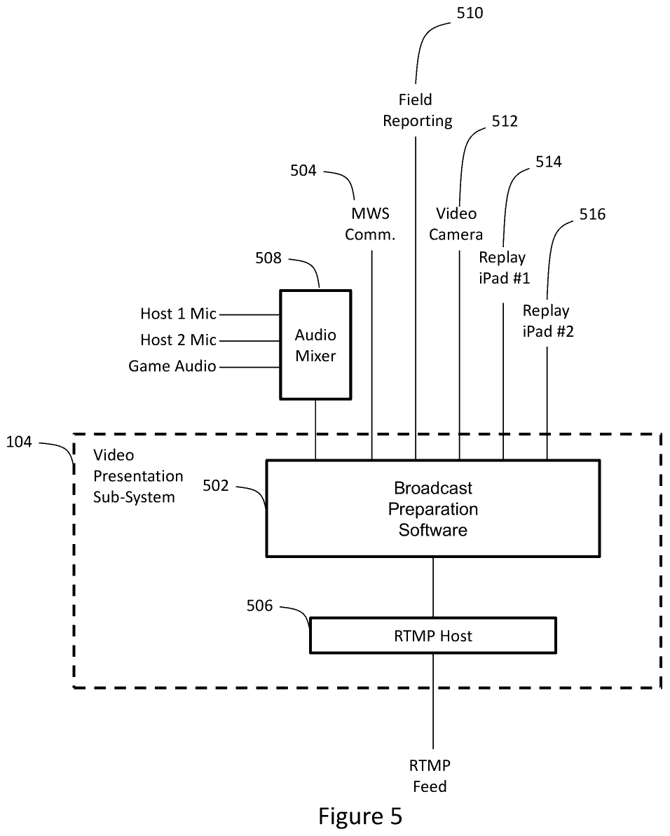

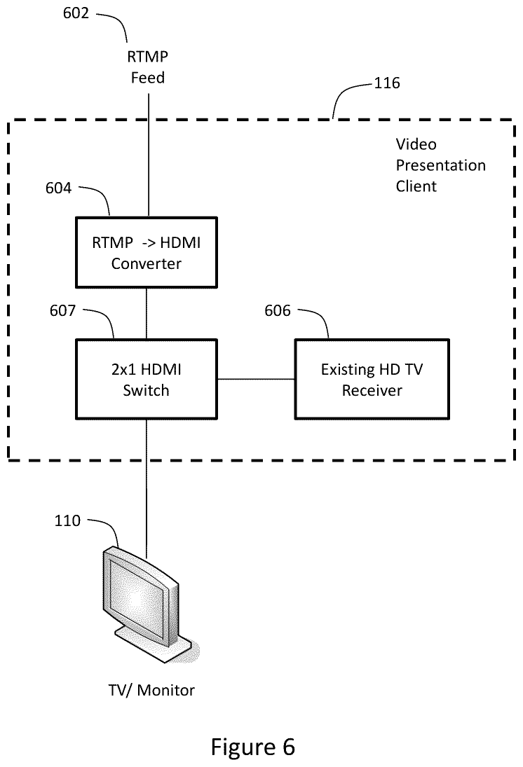

Referring to FIG. 5, there is shown an illustrative Video Presentation System (VPS). In the illustrative embodiment, the video presentation system (VPS) 104 delivers television content to venues communicatively coupled to the centralized gaming system 100 shown in FIG. 1. The illustrative VPS 104 is communicatively coupled to a VPS client 116, which is also shown in FIG. 6 below.

By way of example and not limitation, the VPS 104 may be associated with linked bingo tournament (LBT) games, electronic pull-tab tournaments, and other tournament games more generally. This content presented on illustrative monitors 110 (shown in FIG. 1) complements the game experience on the authorized mobile devices 112. Additionally, the content presented on monitors 110 is configured to involve other patrons at participating venues who are not participating in the games. This may create a social gaming environment that may appeal to a broad spectrum of players.

The illustrative VPS 104, shown in FIG. 5, includes a plurality of inputs that the system may incorporate into broadcast content. For example, communications with the MWS 102 may include a data feed generated by the MWS 102, which provides real time data on the status of an illustrative tournament. The illustrative data feed may include player names, player scores, remaining plays for player game sessions, time remaining in the tournament, prize values and other such tournament information.

A broadcast preparation software module 502 is configured to integrate a plurality of inputs into a broadcast data stream. In the illustrative embodiment, the integration is performed by a suite of commercial products such as Open Broadcaster™, Quicktime™, and proprietary software products. The tasks performed by the broadcast preparation software module 502 includes formatting an illustrative mobile wagering sub-system data feed 504. Note, the mobile wagering sub-system data feed 504 is generated by the mobile wagering sub-system 102. The mobile wagering sub-system data feed 504 includes information such as the tournament leader information, which can be converted into an easily readable display format.

For example, the mobile wagering sub-system data feed 504 may be transmitted over the Internet to a Real Time Messaging Protocol (RTMP) host 506, which may then transmit the data signal from the illustrative RTMP host 506 using an RTMP protocol over the Internet to the illustrative VPS client 116.

The broadcast preparation software module 502 may also be configured to interface with an illustrative audio mixer 508, which accepts a variety of audio feeds. The illustrative audio feeds received by the audio mixer 508 include host microphones and audio from selected live game play; a wide variety of such devices are commercially available. Additionally, the broadcast preparation software module 502 is configured to provide live field reporting 510 from game locations using a tool such as Facetime™. Live field reporting 510 may add excitement to the broadcast. Furthermore, the broadcast preparation software module 502 is configured to interface with various video signals that include studio video cameras 512 and live images captured from illustrative authorized mobile device and replayed as feed 514 and feed 516.

Referring to FIG. 6, there is shown a more detailed view of an illustrative video presentation sub-system (VPS) client 116. In the illustrative embodiment, the VPS client 116 is communicatively coupled to the video presentation sub-system 104 via an illustrative wide area network, e.g. Internet, and a local wireless connection, e.g. local Wi-Fi. The illustrative RTMP feed 602, which is generated by the RTMP host 506, is received by the VPS client 116. The VPS client is also operationally coupled to the illustrative stationary monitor 110.

The RTMP feed 602 is received at an illustrative gaming venue and the RTMP feed 602 is routed to the VPS client 116. By way of example and not of limitation, the RTMP feed 602 is communicated using a dedicated and secure Wi-Fi channel. In the illustrative embodiment, the RTMP feed 602 includes a streaming video data stream, which is converted to a video display signal. For example, the RTMP feed may be converted to an HDMI video signal with an RTMP/HDMI converter 604. For example, the RTMP/HDMI converter 604 may be implemented with special purpose firmware inside an embedded computing element, such as a Raspberry PI™. The resulting video signal generated by the RTMP/HDMI converter 604 is then sent directly to a compatible television or sent to the television using a commercial 2x1 switch 607, such as the Fosman 8024™, which may also be coupled to an existing HDTV data source such as receiver 606.

The illustrative converted HDMI video signal is then presented on the stationary monitor 110. This allows for a variety of installation models. Where there is a television dedicated to use with the VPS the output of the special purpose RTMP/HDMI converter 604 may be left permanently connected to the television or stationary monitor 110. If the television is used for different purposes at different times the data feed to the television can be switched on or off with the introduction of the 2x1 HDMI switch 607, allowing normal use of the television when the VPS data feed is not in use.

The centralized gaming system 100 described in FIG. 1 through FIG. 6 supports a variety of different types of games and game play, including embedded feature electronic pull-tab game play. For the illustrative mobile wagering sub-system 102, a game session is initiated after a wager is received and the game session ends when game play is completed, when a prize is awarded, or according to any other predetermined game mechanic that reflects the game session has ended.

A variety of different game mechanics may be associated with each game session. For example, a tournament game awarding a limited number or prizes may present player rankings for prizes awarded to the ranked players. For another example, an electronic pull-tab tournament game may award limited or no prizes to players based on player rankings, since the electronic pull-tab tickets themselves may award the tournament players prizes.

The player rankings may then be presented on one or more of the authorized mobile devices 112. Additionally, the player rankings may result in the video presentation sub-system 104 generating a player rankings game session output that is presented on the stationary monitors110.

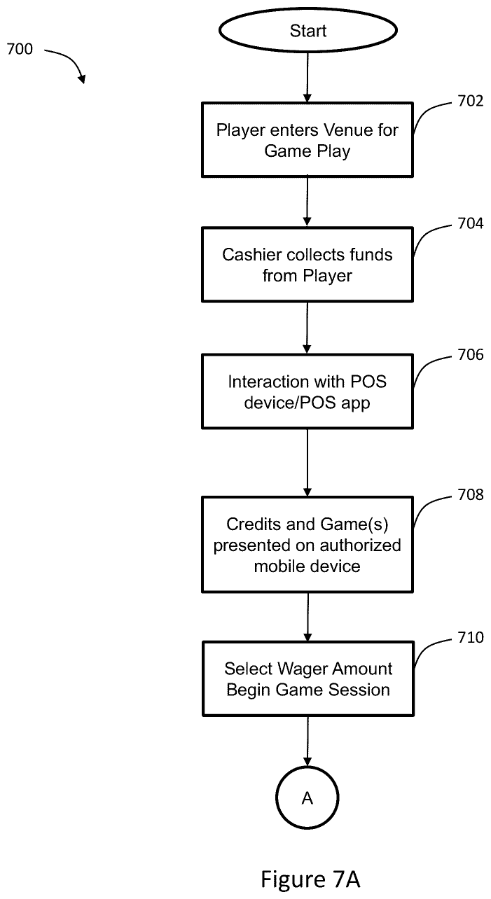

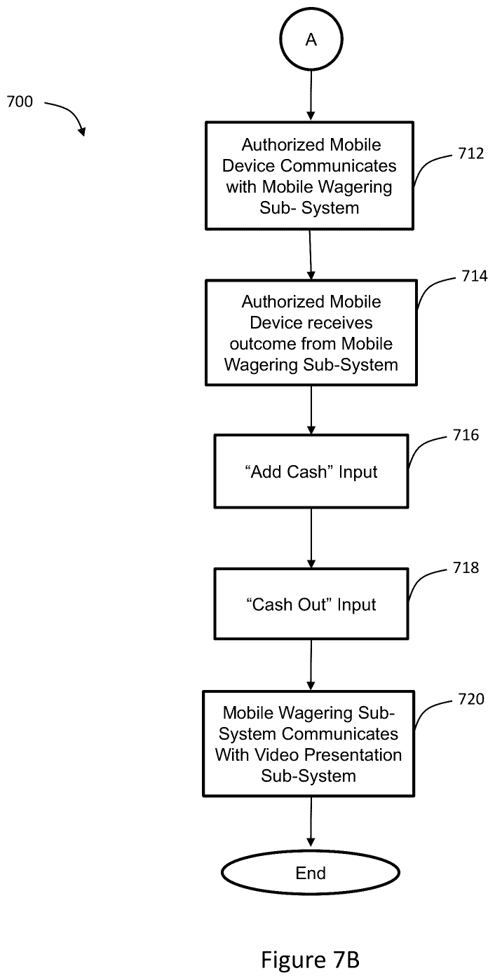

Referring to FIGS. 7A and 7B, there is shown an illustrative centralized gaming method that describes the various steps performed by a player interacting with the gaming system. The illustrative centralized gaming method 700 is at block 702 where an illustrative player enters one of the venues and indicates to the cashier or similar venue employee that the player wants to initiate game play with the centralized gaming system 100. The method then proceeds to block 704 where the illustrative cashier collects monetary funds such as cash, e-money, debit card, credit card and other such monetary funds as are appropriate depending on jurisdictional regulatory requirements.

At block 706, the illustrative cashier then proceeds to interface with a Point-Of-Sale (POS) application on a device such as POS device 114. In another embodiment, the player may interface with a kiosk version of the POS device 114 without the need to interact with a venue employee. In yet another embodiment, the POS application may be running on an authorized mobile device 112 and the player may interact directly with the POS application.

While interfacing with the POS device or POS application at block 706, the illustrative cashier identifies the authorized mobile device 112 associated with the player. The illustrative cashier then proceeds to enter the amount of credits to add to the authorized mobile devices. This amount of credits is stored in illustrative central database 314 (shown in FIG. 3).

At block 708, the total credits, which correspond to the collected funds, are presented on the authorized mobile device 112. The player may then interact with a game application running on the authorized mobile device. The player may also select from a variety of different game applications, which may be presented as a menu of games displayed on the authorized mobile device 112 screen. In operation, various game screens corresponding to the chosen game are presented to the player.

At block 710, the player can select a wager amount for a particular game session. In the illustrative embodiment, the wager amount includes the number of credits the player has selected to be wagered. Depending on jurisdictional requirements wager amounts can be expressed in dollars and cents (or other local currency) or in terms of credits, where each unit of credit has a monetary value. By way of example and not of limitation, the player may then initiate the game session by pressing a PLAY button, which is an illustrative game input received by the authorized mobile device 112.

At block 712, a game request is sent from the authorized mobile device 112 to the mobile wagering sub-system 102. The mobile wagering sub-system 102 processes the game request. In the illustrative embodiment, the mobile wagering subsystem 102 determines a prize result and a graphic representation (or representations) of the prize result. Additionally, the mobile wagering sub-system 102 logs the transaction, updates database game information, and updates an accounting module to reflect the amount spent and player winnings corresponding to the game session. Furthermore, the mobile wagering sub-system 102 sends a response message (or messages) to the authorized mobile device specifying the information to be displayed and the new value of the player account.

The method then proceeds to block 714 where the authorized mobile device 112 receives the outcome(s) from the mobile wagering sub-system 102. For example, the authorized mobile device 112 is configured to present animations and other results associated with the game session. The authorized mobile device 112 may also include an updated accounting of total credits and the prize amounts awarded. After the game session is completed, the player can return to the game menu at any time and select a different game to play.

At block 716, the authorized mobile device receives an “Add Cash” input. By way of example, the player decides to add funds to their play amount by providing the “Add Cash” input, which alerts the illustrative cashier that the player wants to add cash to their session total. The cashier then proceeds to interact with the POS device 114 or POS App (not shown). The illustrative cashier then proceeds to enter the amount of credits to add to the authorized mobile devices and the credits are stored in the illustrative central database 314.

At block 718, the authorized mobile device receives a “Cash Out” input. For example, when the player has finished the game session and wants to “Cash Out” the player presses a “Cash Out” button on the authorized mobile device 112. In the illustrative embodiment, after the authorized mobile device receives the “Cash Out” input, the illustrative cashier is notified that the player desires to “Cash Out.” Using the POS device 114 of the POS App (not shown), the illustrative cashier selects the “Cash Out” input and obtains the total credits remaining on the authorized mobile device after has completed one or more game session. The remaining account total information is received from the mobile wagering sub-system 102. The cashier pays the player the amount due and confirms the payment at the POS. The client device is then available for use by another player.

The method then proceeds to block 720 where mobile wagering sub-system 102 is configured to communicate with the video presentation sub-system 104. At block 720, the video presentation subsystem 104 receives game play information and integrates it with other data sources as described above. The video presentation subsystem 104 generates a video presentation that is broadcast via a private network to participating gaming venues. As described above a stationary monitor 110 is communicatively coupled to the video presentation sub-system 104 via the video presentation client 116. The stationary monitor client is configured to receive and present the game session output generated by the video presentation sub-system. In one illustrative embodiment, the video content is designed to provide enhanced content to the players and to increase the interaction between the players and the games. Additionally, the video content adds interest and excitement to the games. In addition to game-specific content, such as broadcasting a live tournament, the system can be used for a multitude of purposes, including, but not limited to, announcements and pictures on winners, informational videos about sponsoring charities, announcements of new games and upcoming events, advertising, etc.

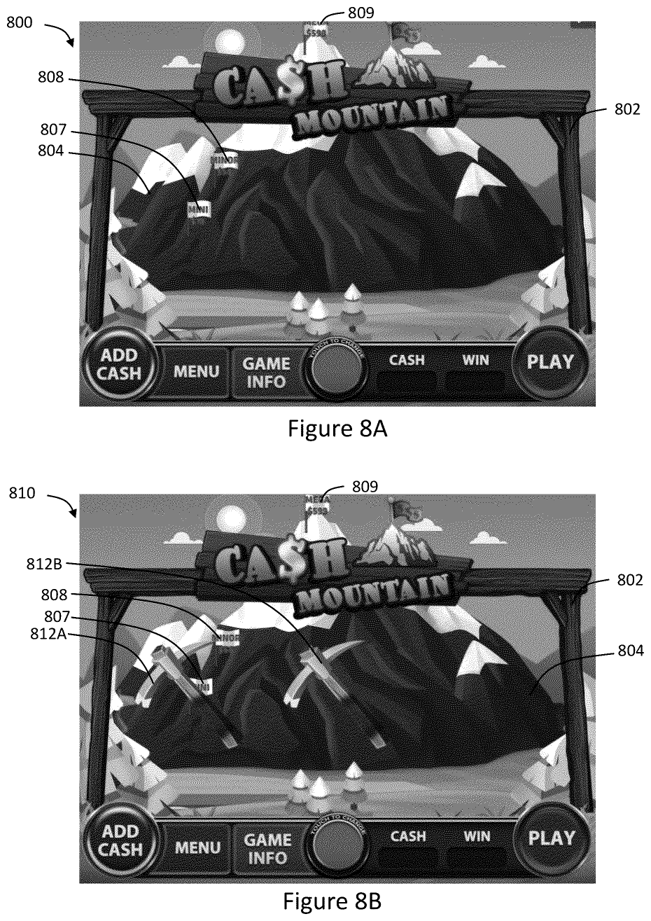

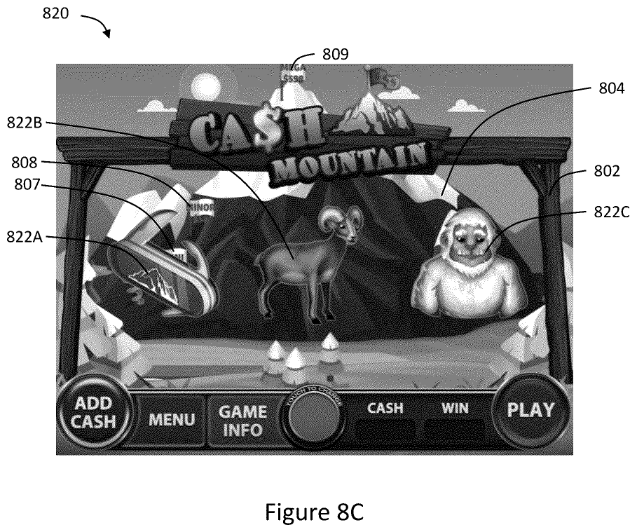

Referring now to FIGS. 8A-C, there are shown illustrative gameplay screens 800, 810, 820 for game symbol reveal animations for an embedded feature electronic pull-tab ticket game. FIG. 8A shows a gameplay screen 800 for a Cash Mountain embedded feature electronic pull-tab game. The gameplay screen 800 includes a foreground frame 802, in which three (3) game symbols will be displayed along a single row at a later stage of the game. The foreground frame 802 lies in front and atop a background display area with a mountain climbing pre-reveal scene 804 with a mini award 807, a minor award 808, and a mega award 809 visible. The mini award 807 is near the base of the mountain climbing pre-reveal scene 804 and displays an associated award value of $10. The minor award 808 is near the middle of the mountain climbing pre-reveal scene 804 and displays an associated award value of $50. The mega award 809 is near the peak of the mountain climbing pre-reveal scene 804 and displays an associated award value of $599. The mini award 806, minor award 808, and mega award 809 are arranged on the mountain climbing pre-reveal scene 804 such that the award markers 807, 808, 809 are shown ascending the mountain climbing pre-reveal scene 804 in order of increasing award value. The award values for the mini award 807, the minor award 808, and the mega award 809 are merely illustrative and may vary, such that the mini award 807 is the smallest of the awards, the minor award 808 is greater than the mini award 807 and lesser than the mega award 809, and the mega award 809 is the largest displayed award. In some embodiments, a further award is displayed, a major award (not shown), situated in value and on the mountain climbing pre-reveal scene 804 between the minor award 808 and the mega award 809.

While the illustrative embodiment presents a 3-symbol row game display area in the foreground frame 802, the term “row” is interchangeable with similar terms, such as “grid,” “column,” or “reel,” unless otherwise stated herein. Further, a grid may comprise a single row, a single column, multiple rows, and/or multiple columns, and is not limited to the illustrative 3-symbol row depicted in FIG. 8A and other figures herein. Further still, each row or column of a grid is not limited to three (3) game symbol display positions, and may include more or fewer game symbol display positions.

FIG. 8B shows a gameplay screen 810 for the Cash Mountain embedded feature electronic pull-tab game. The gameplay screen 810 includes a foreground frame 802, in which a first game symbol 812A and a second game symbol 812B are displayed. The foreground frame 802, as well as the game symbols 812A and 812B, lie in front and atop a background display area embedded within the foreground display with a mountain climbing pre-reveal scene 804 with a mini award 807, a minor award 808, and a mega award 809 visible. The mini award 807 is near the base of the mountain climbing pre-reveal scene 804, behind the first game symbol 812A, and displays an associated award value of $10. The minor award 808 is near the middle of the mountain climbing pre-reveal scene 804 and displays an associated award value of $50. The mega award 809 is near the peak of the mountain climbing pre-reveal scene 804 and displays an associated award value of $599. The mini award 807, the minor award 808, and mega award 809 are arranged on the mountain climbing pre-reveal scene 804 are shown ascending the mountain climbing pre-reveal scene 804 in order of increasing award value. The award values for the mini award 807, the minor award 808, and the mega award 809 are merely illustrative and may vary, such that the mini award 807 is the smallest of the awards, the minor award 808 is greater than the mini award 807 and lesser than the mega award 809, and the mega award 809 is the largest displayed award. In some embodiments, a further award is displayed, a major award (not shown), situated in value and on the mountain climbing pre-reveal scene 804 between the minor award 808 and the mega award 809.

FIG. 8C shows a gameplay screen 820 for the Cash Mountain embedded feature electronic pull-tab game. The gameplay screen 820 includes a foreground frame 802, in which a first game symbol 822A, a second game symbol 822B, and a third game symbol 822C are displayed. The foreground frame 802, as well as the game symbols 822A, 822B, and 822C, lie in front and atop a background display area embedded within the foreground display with a mountain climbing pre-reveal scene 804 with a mini award 807, a minor award 808, and a mega award 809 visible. The mini award 807 is near the base of the mountain climbing pre-reveal scene 804, behind the first game symbol 822A, and displays an associated award value of $10. The minor award 808 is near the middle of the mountain climbing pre-reveal scene 804 and displays an associated award value of $50. The mega award 809 is near the peak of the mountain climbing pre-reveal scene 804 and displays an associated award value of $599. The mini award 807, the minor award 828, and mega award 809 are arranged on the mountain climbing pre-reveal scene 804 ascending the mountain climbing pre-reveal scene 804 in order of increasing award value. The award values for the mini award 807, the minor award 808, and the mega award 809 are merely illustrative and may vary, such that the mini award 807 is the smallest of the awards, the minor award 808 is greater than the mini award 807 and lesser than the mega award 809, and the mega award 809 is the largest displayed award. In some embodiments, a further award is displayed, a major award (not shown), situated in value and on the mountain climbing pre-reveal scene 804 between the minor award 808 and the mega award 809.

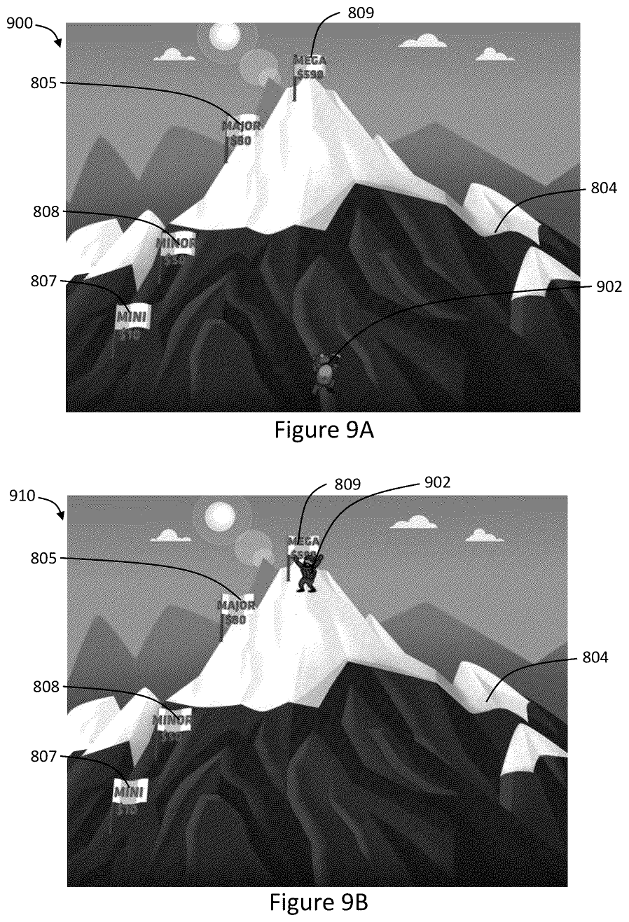

With reference now to FIGS. 9A and 9B, there are shown game screen displays 900 and 910 of a game screen shift that displays only the mountain climbing pre-reveal scene 804. Such a game screen shift may include a zoom-in action, a pan action, a rotate action, or any combination thereof such that the game screen view shifts from displaying the foreground, the foreground frame (not shown) for game symbols, and the background display area to displaying only the background display area. In some embodiments, the screen shift to display of the background display area may include a re-sizing and/or re-location of the game symbols and/or empty game symbol display positions so that they are visible in the background display area.

In FIG. 9A, there is shown game screen display 900 of the mountain climbing pre-reveal scene 804 near the beginning of an entertaining animation. A mini award flag 807 is shown near the bottom of the mountain climbing pre-reveal scene 804, a minor award flag 808 is shown near the middle of the mountain climbing pre-reveal scene 804 above the mini award flag 807, a major award flag 805 is shown on the upper half of the mounting climbing pre-reveal scene 804 above both the mini award flag 807 and the minor award flag 808, and a mega award flag 809 is shown near the peak of the mounting climbing pre-reveal scene 804 above all other award flags 807, 808, and 805. Further, a mountain climbing figure or avatar 902 is shown near the bottom of the mounting climbing pre-reveal scene 804 ascending the mountain. The mini award 807 displays an associated award value of $10, the minor award 808 displays an associated award value of $50, the major award 805 displays an associated award value of $80, and the mega award 809 displays an associated award value of $599. The mini award 807, the minor award 808, the major award 805, and mega award 809 are arranged on the mountain climbing pre-reveal scene 804 ascending the mountain climbing pre-reveal scene 804 in order of increasing award value. The award values for the mini award 807, the minor award 808, the major award 805, and the mega award 809 are merely illustrative and may vary, such that the mini award 807 is the smallest of the awards, the minor award 808 is greater than the mini award 807, the major award 805 is greater than the minor award 808, and the mega award 809 is the largest displayed award.

In the illustrative embodiment, the entertaining animations disclosed herein are elements of the primary game session. In some embodiments, the entertaining animations disclosed herein are elements of (or comprise entirely) a bonus game session.

FIG. 9B shows the same mountain climbing pre-reveal scene 804 as is shown in FIG. 9A at a later stage of the entertaining animation where the mountain climbing figure or avatar 902 has ascended the mountain and reached the mega award flag 809. In the illustrative embodiment, when mountain climber 902 reaches the height of an award flag, this indicates that the player has won the amount indicated on the award flag. Thus, as the entertaining animation occurs and the mountain climber 902 ascends the mountain 804, the player is informed of the minimum amount won from the game session. Once the mountain climber 902 stops ascending, the player knows that they have won the amount on the flag level with or most closely below the mountain climber 902. In the illustrative embodiment, the mountain climber 902 ascends to the peak of the cash mountain and the player wins the mega award value of $599. The mountain climber's 902 ascent may take several seconds, building player anticipation.

In some embodiments, the animations of FIGS. 9A and 9B may be skipped by player input, such as pressing a button. Skipping the entertaining animation may be desirable for players that have previously witnessed the animation and only desire to see the outcome of the animation, instead of the animation itself.

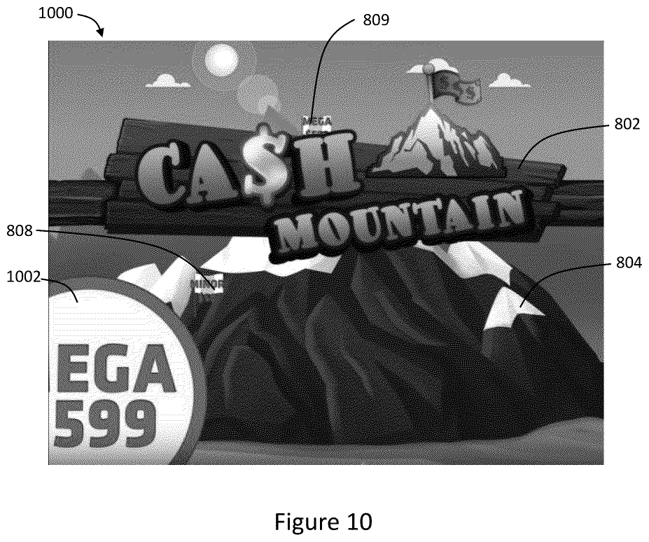

With reference now to FIG. 10, there is shown a game screen shift or transition 1000 from the background mounting climbing pre-reveal scene 804 to the foreground game symbol display frame 802 after completion of the entertaining animation in FIG. 9B where the player won the mega award 809 of $599. In the game screen shift or transition 1000, the foreground game symbol display frame 802 can been seen coming into the game screen display on top of the background mounting climbing pre-reveal scene 804. Additionally, a game symbol 1002 representing the mega award 809 is seen coming into the game screen display on top of the background mounting climbing pre-reveal scene 804. The game symbol 1002 may be a game symbol or a pre-reveal game symbol.

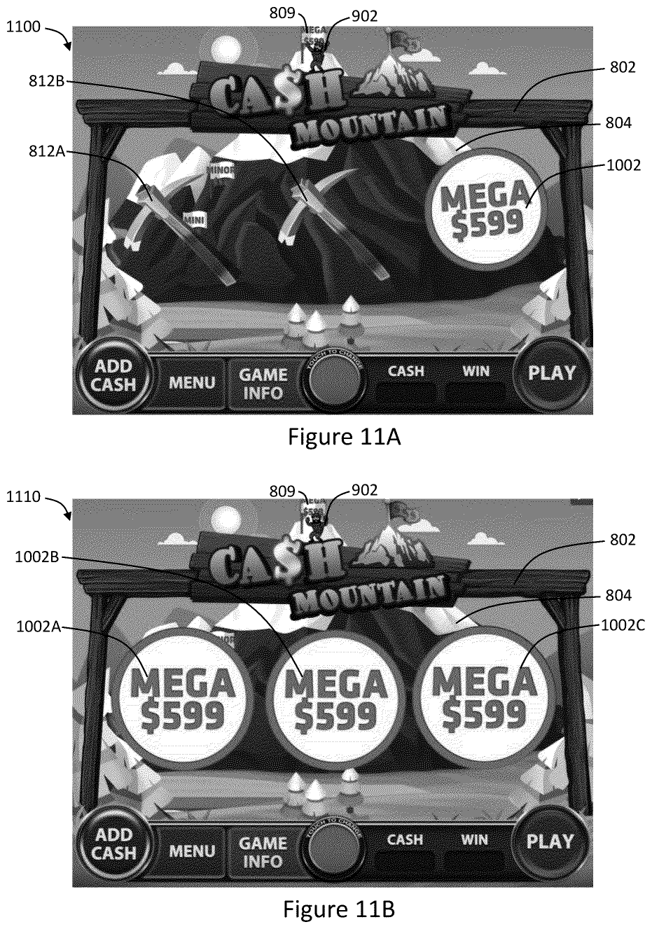

Referring now to FIGS. 11A and 11B, there are shown illustrative game screen displays of game symbol display embodiments 1100 and 1110. In FIG. 11A, the game screen display 1100 shows the final symbol reveal of the pre-reveal symbol 1002 after the entertaining animation and screen shift back to the foreground display. Game screen display 1100 represents a continuation of game play from game play display 810 discussed above in FIG. 8B. In this embodiment, after displaying the first two game symbols 812A and 812B in FIG. 8B, and presenting the entertaining mountain climbing animation in FIGS. 9A and 9B where the player won the mega award 809 when the mountain climber 902 reached the mountain peak, the mega award symbol 1002 is included as the third and final game symbol in the foreground display frame 802 with the mountain climbing pre-reveal display scene 804 back in the background.

In FIG. 11B, the game screen display 1110 shows the final symbol reveal of the pre-reveal symbols 1002A, 1002B, and 1002C after the entertaining animation and screen shift back to the foreground display. Game screen display 1110 represents a continuation of game play from game play display 800 discussed above in FIG. 8A. In this embodiment, after initiating game play and displaying three empty game symbol display positions in the foreground frame 802, the display 800 animated (i.e., shook or rattled) to indicate a pre-reveal and shifted the screen view to that of FIGS. 9A and 9B for the entertaining mountain climbing animation. In the embodiment of FIG. 11, when the mountain climber 902 reached the peak and the player was awarded the mega prize 809, the screen shift back to the foreground display resulted in game screen 1110 where the mega prize symbol 1002 occupies all three game symbol display positions and overlays the background mountain climbing pre-reveal scene 804.

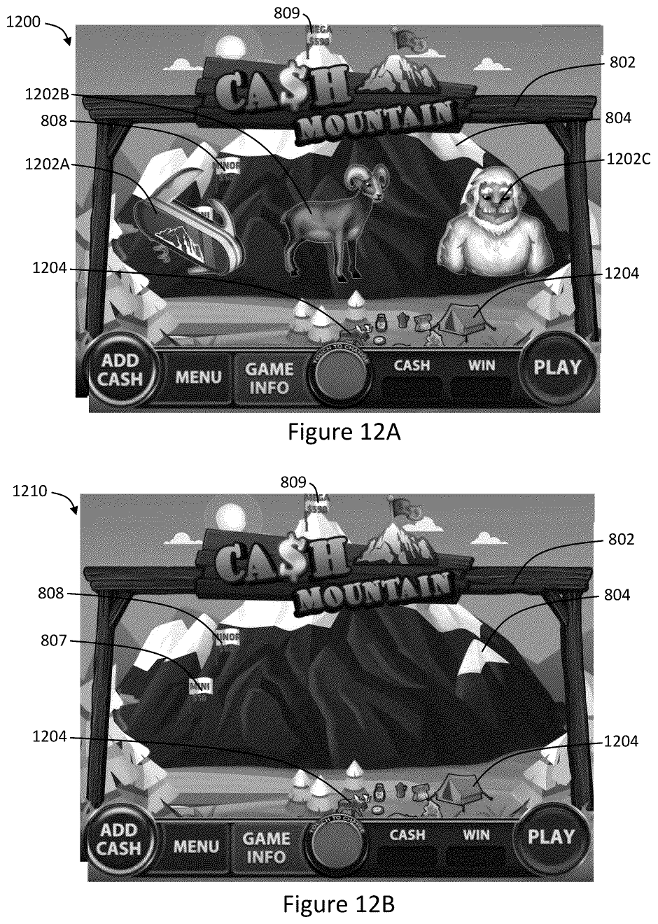

Referring now to FIGS. 12A and 12B, there are shown game screen displays 1200 and 1210 for a pick-em embedded feature electronic pull-tab ticket game. The pick-em embedded feature may be a game mechanic or a pre-reveal game mechanic that allows further player interaction during a game session. In the illustrative embodiment shown in FIG. 12A, the foreground display frame 802 continues to lie in front and atop the background display area with the mountain climbing pre-reveal scene 804 having the minor award 808 and mega award 809 visible. Additionally, pick-em symbols 1204 are visible in the background, behind three (3) displayed game symbols 1202A, 1202B, 1202C in the foreground display frame 802. The non-limiting, illustrative pick-em symbols 1204 are embodied as a moose, a tent, a lantern, a coffee pot, a compass, a campfire, and a backpack, and generally with camping-related depictions.

In the illustrative embodiment shown in FIG. 12B, the foreground display frame 802 continues to lie in front and atop the background display area with the mountain climbing pre-reveal scene 804 having the mini award 807, the minor award 808, and mega award 809 visible, but without any game symbols displayed in the game symbol display positions of the foreground display 802. As with FIG. 12A, the illustrative pick-em symbols 1204 are additionally visible in the background mountain climbing pre-reveal scene 804.

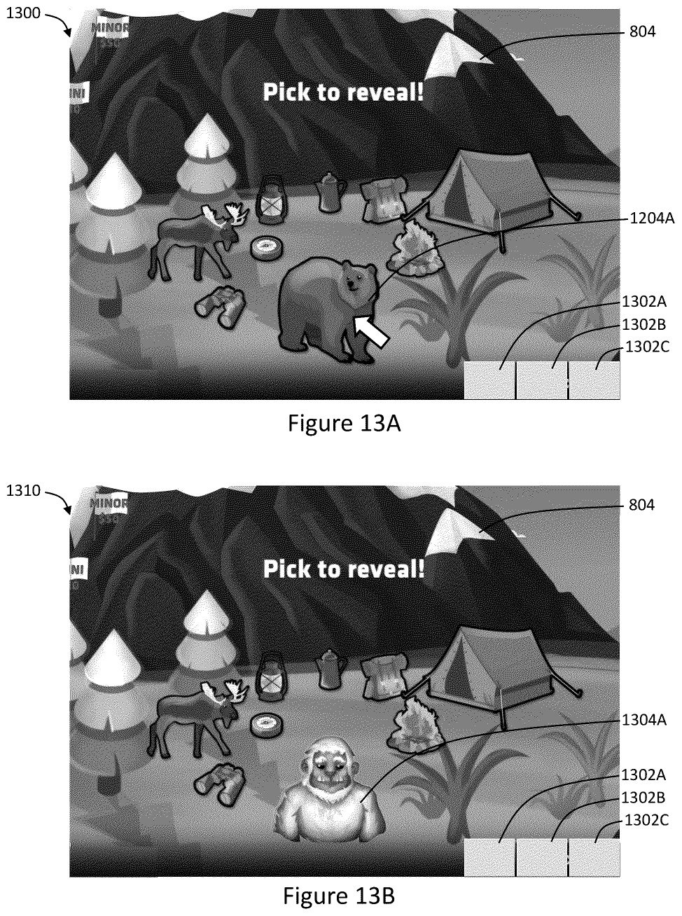

With reference now to FIGS. 13A and 13B, there are shown shifted screen views 1300 and 1310 focused on the pick-em symbols 1204 in the background display area 804. As described above, the screen shift may be achieved by a zoom-in action, a pan action, a rotate action, or any combination thereof such that the game screen view shifts from displaying the foreground, the foreground frame (not shown) for game symbols, and the background display area 804 to displaying only the background display area 804 or some portion thereof.

In FIG. 13A, the view 1300 of the background display area 804 includes game symbol display positions 1302A, 1302B, and 1302C that have been re-sized to occupy a smaller innocuous portion of the screen display 1300. In this illustrative embodiment, the player is selecting with player input, such as a click, button press, or touch screen selection, the bear pick-em symbol 1204A.

In FIG. 13B, the view 1310 of the background display area 804 continues to include the game symbol display positions 1302A, 1302B, and 1302C that have been re-sized to occupy a smaller innocuous portion of the screen display 1300, but the selected bear pick-em symbol has been replaced through a reveal animation with a yeti game symbol 1304A.

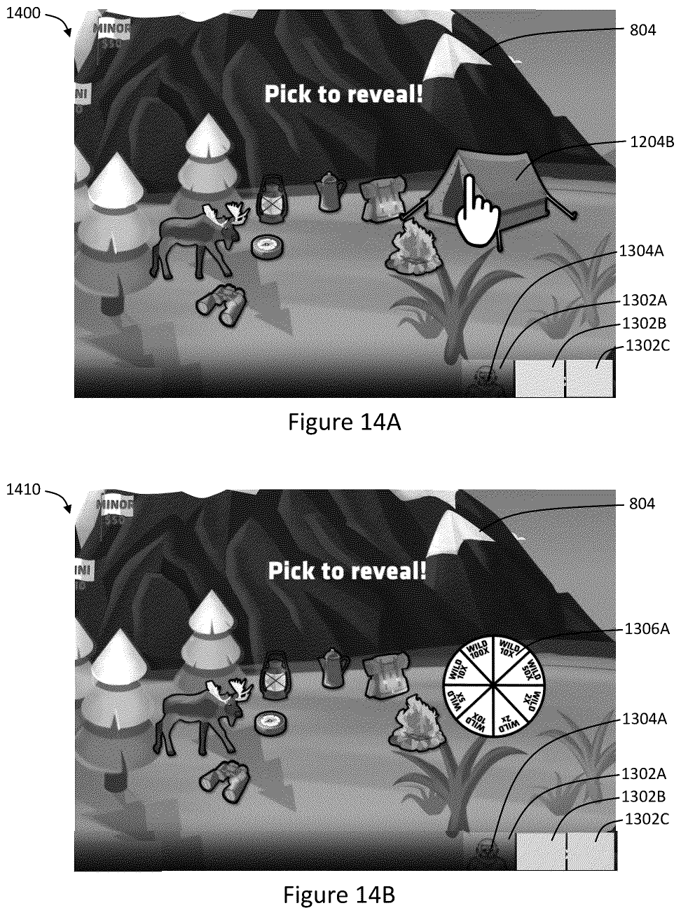

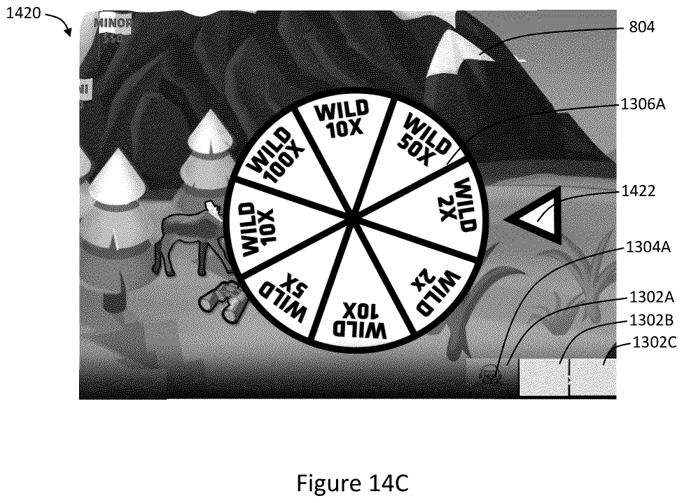

Referring now to FIGS. 14A-C, there are shown shifted screen views 1400, 1410, and 1420 focused on the pick-em symbols 1204 in the background display area 804 after the bear pick-em symbol (not shown) has been selected, converted to a game symbol 1304A, and removed from the pool of pick-em symbols selectable by a player.

In FIG. 14A, the view 1400 of the background display area 804 shows the converted yeti game symbol 1304A now occupying game symbol display position 1302A, while game symbol display positions 1302B and 1302C remain empty. Additionally, the bear pick-em symbol continues to be absent from the view 1400, as the symbol was selected and has been used. Of the remaining pick-em symbols 1204, the player is selecting the tent pick-em symbol 1204B.

In FIG. 14B, the view 1410 of the background display area 804 shows the selected tent pick-em symbol has been revealed to be a pre-reveal multiplier wheel 1306A, which the player may spin to determine the pre-reveal multiplier and/or symbol awarded. The player may cause the wheel 1306A to spin through a player input or the game may institute a timer to begin the wheel spin animation after a predetermined amount of time.

In FIG. 14C, the view 1420 of the background display area 804 shows a pre-reveal animation of the wheel spin with an indicator arrow 1422 indicating that the player has been awarded a “WILD 2X” multiplier game symbol. In the illustrative embodiment, the pre-reveal animation of the wheel spin causes the wheel 1306A and the indicator 1422 to become larger and centered in the players view screen 1420.

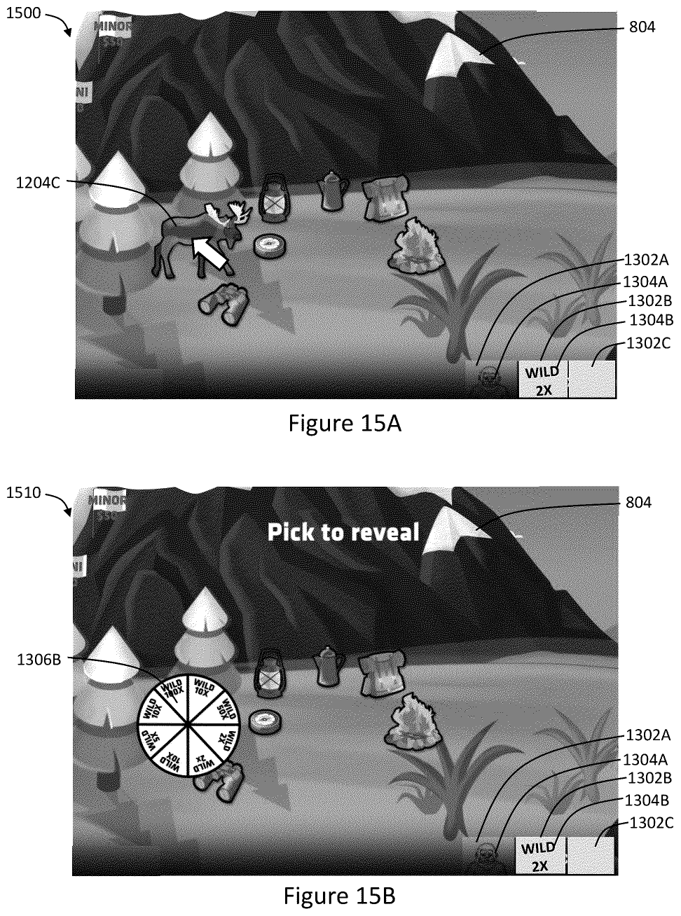

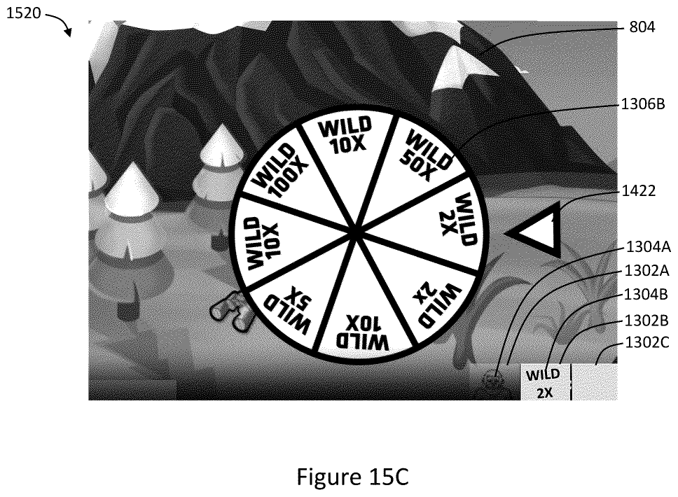

With reference now to FIGS. 15A-C, there are shown shifted screen views 1500, 1510, and 1520 focused on the pick-em symbols 1204 in the background display area 804 after the bear pick-em symbol (not shown) and the tent pick-em symbol (not shown) have been selected, revealed as game symbols 1304A and 1304B, and removed from the pool of pick-em symbols selectable by the player.

In FIG. 15A, the view 1500 of the background display area 804 shows the revealed yeti game symbol 1304A occupying game symbol display position 1302A, the revealed WILD 2X game symbol 1304B now occupying game symbol display position 1302B, and the game symbol display position 1302C remaining empty. In this illustrative embodiment, the player is selecting with player input, such as a click, button press, or touch screen selection, the moose pick-em symbol 1204C.

In FIG. 15B, the view 1510 of the background display area 804 shows the selected moose pick-em symbol has been revealed to be a pre-reveal multiplier wheel 1306B, which the player may spin to determine the pre-reveal multiplier and/or symbol awarded.

In FIG. 15C, the view 1520 of the background display area 804 shows a pre-reveal animation of the wheel spin with an indicator arrow 1422 indicating that the player has been awarded a “WILD 2X” multiplier game symbol. In the illustrative embodiment, the pre-reveal animation of the wheel spin causes the wheel 1306B and the indicator 1422 to become larger and centered in the players view screen 1520.

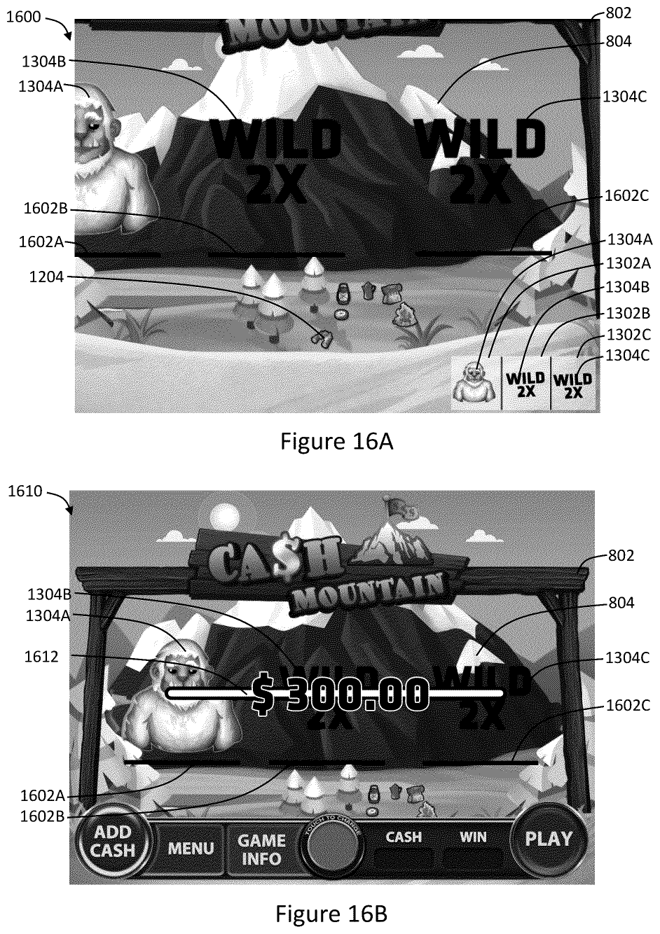

Referring now to FIGS. 16A and 16B, there are shown final and award game screen displays 1600 and 1610 after the three pick-em rounds of FIGS. 13A, 13B, 14A-C, and 15A-C have been completed.

In FIG. 16A, the game screen display 1600 has shifted back to the foreground display frame area 802 to display the game symbols 1304A-C selected during the pick-em game play, with the remaining pick-em symbols 1204 still visible in the background display area 804. The game symbols 1304A-C are now displayed in game symbol display positions 1602A-C within the foreground display frame area 802, as well as continuing to be displayed in the smaller re-sized game symbol display positions 1302A-C.

In FIG. 16B, the game screen display 1610 now further includes a win line 1612, indicating that the game symbols 1304A-C displayed within the foreground display area 802 in display positions 1602A-C have yielded an award for the game session of $300.00.

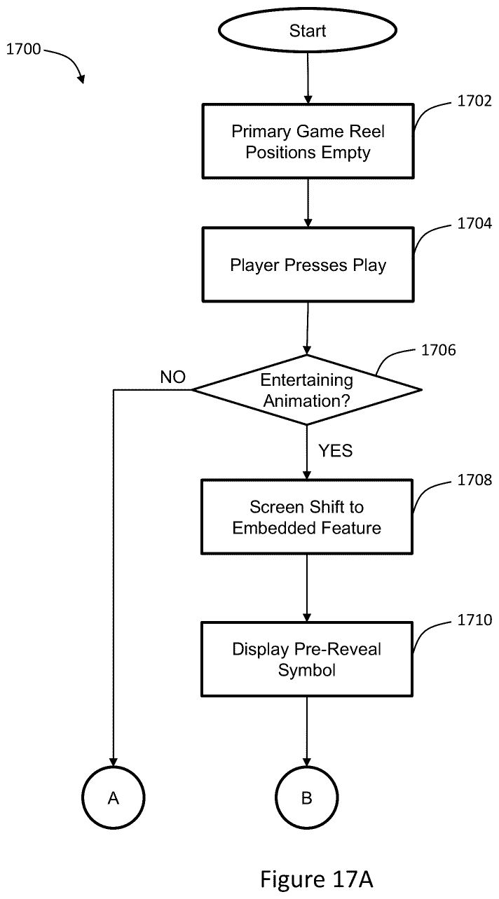

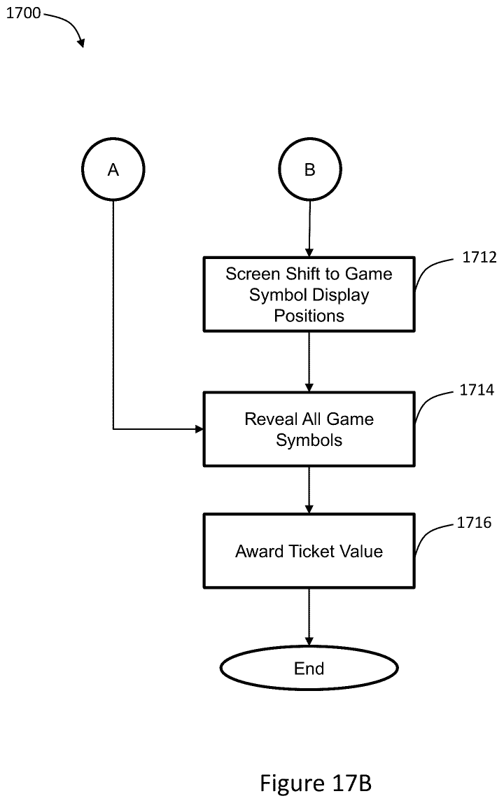

With reference now to FIGS. 17A and 17B, there is shown a flow chart 1700 for an illustrative method of providing an embedded feature electronic game where the pre-reveal animation occurs prior to the reveal of any game symbols. The method 1700 begins with the presentation of an empty foreground display 1702 lacking any revealed game symbols, but including a background display of a potential pre-reveal animation, such as the mountain climbing scene 804 shown in FIG. 8A above.

The method 1700 continues when a player initiates a game with player input 1704, such as by pressing play on the screen or on the gaming device.

The player input received in step 1704 triggers the gaming device to proceed to decision diamond 1706, where a determination is made of whether an entertaining pre-reveal animation is awarded or presented to the player. This determination may be made by the centralized gaming system or locally by the gaming device and includes examination of the electronic ticket or game session for an indication that a pre-reveal is included. In the illustrative embodiment, each electronic pull-tab ticket includes a ticket value, a pre-reveal value, a foreground display area, and a background display area. The ticket value denotes the award yielded by the associated ticket. The pre-reveal value is metadata indicating the absence or presence of a pre-reveal animation associated with the ticket, and if a pre-reveal animation is associated with the ticket—the particular animation to be displayed and provided to the player. Where the metadata indicates that no pre-reveal animation is to be presented for a ticket, the metadata encoding the pre-reveal value may be zero or a zero value.

When it is determined that no pre-reveal is included in the game session ticket, the method proceeds to step 1714 where the game symbols are simply revealed to the player and the outcome of the game session is communicated through the gaming device display screen, such as shown in FIG. 8C. When it is determined that a pre-reveal is included in the game session ticket, the method proceeds to step 1708 where a screen shift occurs that results in the gaming device display showing a background pre-reveal display area, such as in FIGS. 9A and 13A. Such a game screen shift may include a zoom-in action, a pan action, a rotate action, or any combination thereof such that the game screen view shifts from displaying the foreground, the foreground frame for game symbols, and the background display area to displaying only the background display area. In some embodiments, this screen shift action provides the player with a continuous view that apparently travels from a first view location displaying the foreground and background to a second view location where only the background can be seen. The screen shift may be or include an animation, such as an entertaining animation relating to the game theme and symbols.

Upon completing the screen shift action, the method continues at step 1710 where a pre-reveal symbol is displayed in the background display area. In some embodiments, the pre-reveal symbol may include a pre-reveal animation, such as a climbing ascending a mountain past various levels of pre-reveal payout, for example the scene depicted in FIG. 9B. In some embodiments, the pre-reveal symbol may include several new symbols, such as the pick-em symbols depicted in FIG. 13A. In the pick-em example, the pre-reveal symbol would further include a player input, such as a selection of one or more of the pick-em symbols for reveal.

Upon completion of the pre-reveal symbol display, the method proceeds to step 1712 where another screen shift action is performed to shift the player's view back to the foreground display area. The screen shift action performed may include a zoom-out action, a pan action, a rotate action, or any combination thereof such that the game screen view shifts back from displaying the background to displaying the foreground most prominently—with the background display area still visible behind the foreground display elements.

Once the player's view is focused again on the foreground display area, the game symbols are revealed at step 1714. The revealed symbols and any win amount are consistent with the pre-reveal symbol displayed previously. In some embodiments, the pre-reveal symbol display included a reveal of one or more game symbols for display in the game symbol display positions in the foreground. In such embodiments, the game symbols are not revealed, but instead simply present when the screen shifts back to the foreground display area.

At step 1716, the method terminates after presenting and delivering to the player an award amount associated with the game session ticket. In the illustrative embodiment, the gaming device reads metadata from the receive ticket indicating an award value associated with that ticket, i.e., a ticket value.

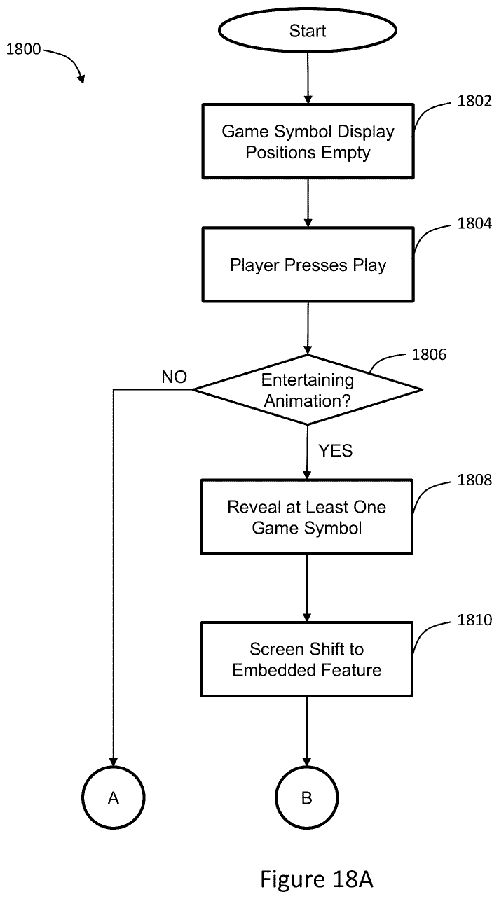

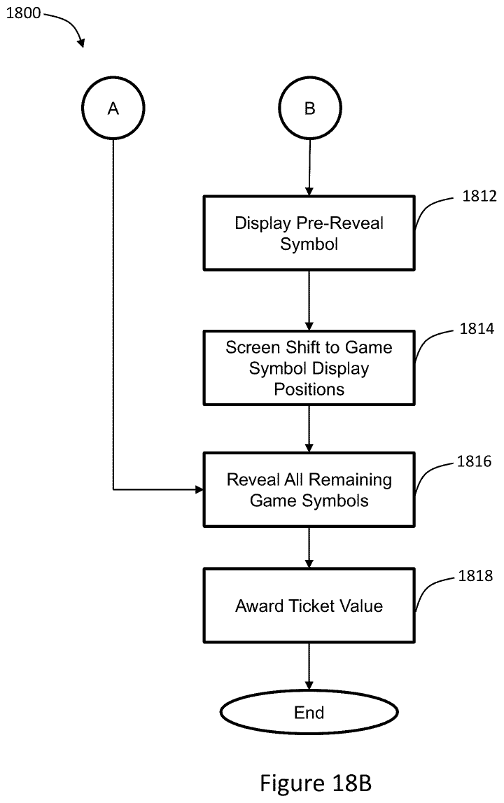

Referring now to FIGS. 18A and 18B, there is shown a flow chart 1800 for an illustrative method of providing an embedded feature electronic game where the pre-reveal animation occurs after the reveal of at least one game symbol, but prior to the reveal of all the game symbols. The method 1800 begins with the presentation of an empty foreground display 1802 lacking any revealed game symbols, but including a background display of a potential pre-reveal animation, such as the mountain climbing scene 804 shown in FIG. 8A above.

The method 1800 continues when a player initiates a game with player input 1804, such as by pressing play on the screen or on the gaming device.

The player input received in step 1804 triggers the gaming device to proceed to decision diamond 1806, where a determination is made of whether a pre-reveal is awarded. This determination may be made by the centralized gaming system or locally by the gaming device and includes examination of the electronic ticket or game session for an indication that a pre-reveal included. When it is determined that no pre-reveal is included in the game session ticket, the method proceeds to step 1816 where the game symbols are simply revealed to the player and the outcome of the game session is communicated through the gaming device display screen, such as shown in FIG. 8C. When it is determined that a pre-reveal is included in the game session ticket, the method proceeds to step 1808 where at least one game symbol, but not all game symbols, is revealed to the player in the foreground display area, such as in FIG. 8B.

The method then continues at step 1810, where a screen shift occurs that results in the gaming device display showing a background pre-reveal display area, such as in FIGS. 9A and 13A. The screen shift may be or include an animation, such as an entertaining animation relating to the game theme and symbols.

Upon completing the screen shift action, the method continues at step 1812 where a pre-reveal symbol is displayed in the background display area. In some embodiments, the pre-reveal symbol may include a pre-reveal animation, such as a climbing ascending a mountain past various levels of pre-reveal payout, for example the scene depicted in FIG. 9B. In some embodiments, the pre-reveal symbol may include several new symbols, such as the pick-em symbols depicted in FIG. 13A. In the pick-em example, the pre-reveal symbol may further include a player input, such as a selection of one or more of the pick-em symbols for reveal.

Upon completion of the pre-reveal symbol display, the method proceeds to step 1814 where another screen shift action is performed to shift the player's view back to the foreground display area.

Once the player's view is focused again on the foreground display area, the remaining unrevealed game symbols are revealed at step 1816. The revealed symbols and any win amount are consistent with the pre-reveal symbol displayed previously. In some embodiments, the pre-reveal symbol display included a reveal of one or more game symbols for display in the game symbol display positions in the foreground. In such embodiments, the game symbols are not revealed, but instead simply present when the screen shifts back to the foreground display area.

At step 1818, the method terminates after presenting and delivering to the player an award amount associated with the game session ticket.

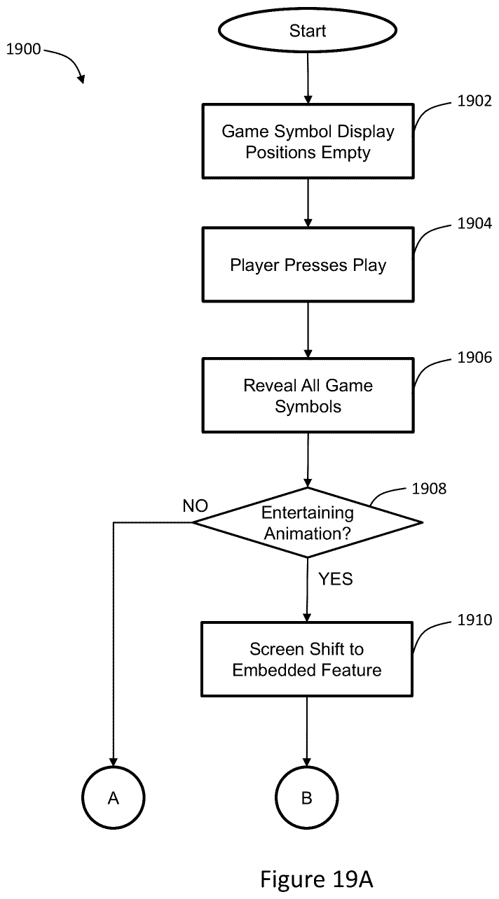

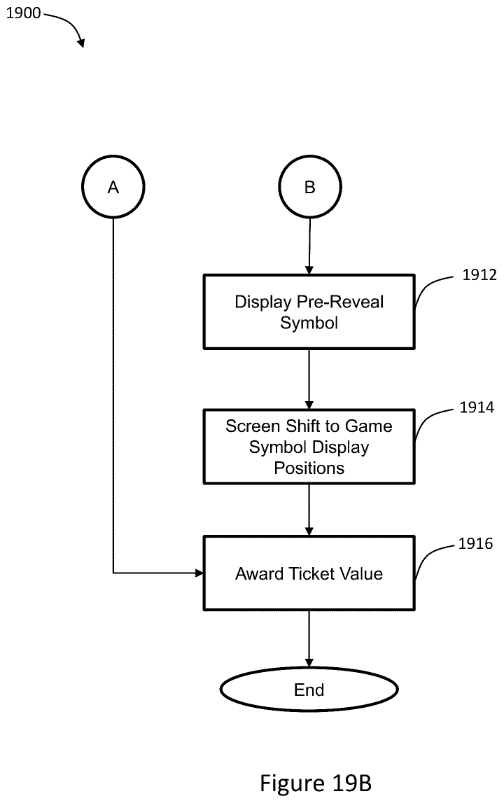

With reference now to FIGS. 19A and 19B, there is shown a flow chart 1900 for an illustrative method of providing an embedded feature electronic game where the pre-reveal animation occurs after the reveal of all game symbols. The method 1900 begins with the presentation of an empty foreground display 1902 lacking any revealed game symbols, but including a background display of a potential pre-reveal animation, such as the mountain climbing scene 804 shown in FIG. 8A above.

The method 1900 continues when a player initiates a game with player input 1904, such as by pressing play on the screen or on the gaming device.

The player input received in step 1904 triggers the gaming device to reveal all of the game symbols at step 1906 and proceed to decision diamond 1908, where a determination is made of whether a pre-reveal is awarded. This determination may be made by the centralized gaming system or locally by the gaming device and includes examination of the electronic ticket or game session for an indication that a pre-reveal is included. When it is determined that no pre-reveal is included in the game session ticket, the method proceeds to step 1916 where the award value associated with the displayed game symbols is presented and awarded to the player. When it is determined that a pre-reveal is included in the game session ticket, the method proceeds to step 1910 where a screen shift occurs that results in the gaming device display showing a background pre-reveal display area, such as in FIGS. 9A and 13A. The screen shift may be or include an animation, such as an entertaining animation relating to the game theme and symbols.

Upon completing the screen shift action, the method continues at step 1912 where a pre-reveal symbol is displayed in the background display area. In some embodiments, the pre-reveal symbol may include a pre-reveal animation, such as a climbing ascending a mountain past various levels of pre-reveal payout, for example the scene depicted in FIG. 9B. In some embodiments, the pre-reveal symbol may include several new symbols, such as the pick-em symbols depicted in FIG. 13A. In the pick-em example, the pre-reveal symbol may further include a player input, such as a selection of one or more of the pick-em symbols for reveal.

Upon completion of the pre-reveal symbol display, the method proceeds to step 1914 where another screen shift action is performed to shift the player's view back to the foreground display area.

Once the player's view is focused again on the foreground display area, the previously revealed game symbols are shown and a corresponding award presented at step 1916. The revealed symbols and any win amount are consistent with the pre-reveal symbol displayed previously. In some embodiments, the pre-reveal symbol display included a reveal of one or more game symbols for display in the game symbol display positions in the foreground. In such embodiments, the game symbols are not revealed, but instead simply present when the screen shifts back to the foreground display area.

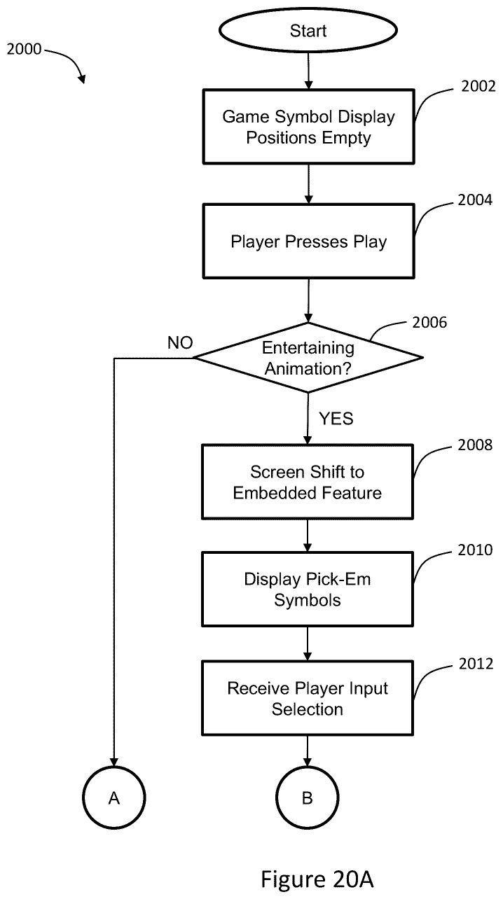

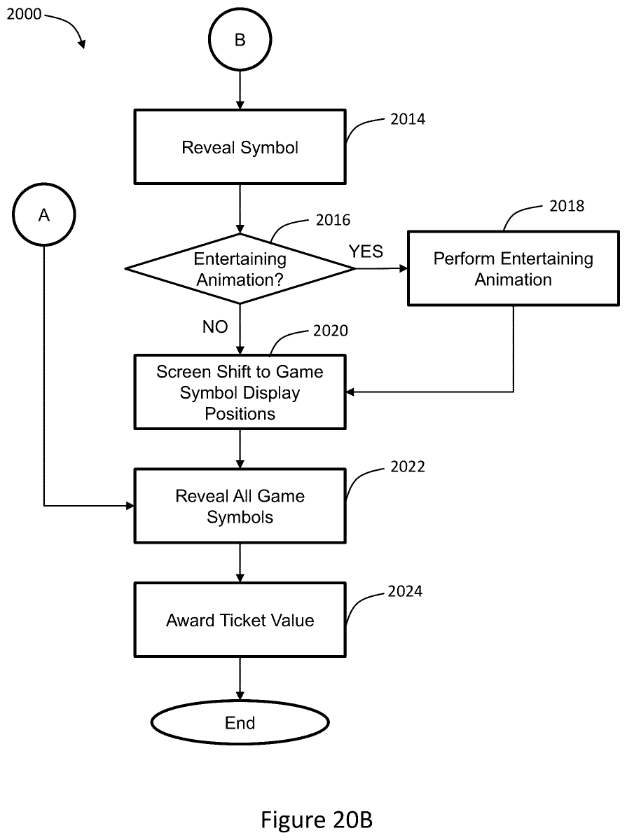

Referring now to FIGS. 20A and 20B, there is shown a flow chart 2000 for an illustrative method of providing an embedded pick-em feature electronic game where the pre-reveal animation occurs prior to the reveal of any game symbols. The method 2000 begins with the presentation of an empty foreground display 2002 lacking any revealed game symbols, but including a background display of a potential pre-reveal animation, such as the mountain climbing scene 804 and pick-em symbols 1204 shown in FIGS. 12A and 12B above.

The method 2000 continues when a player initiates a game with player input 2004, such as by pressing play on the screen or on the gaming device.

The player input received in step 2004 triggers the gaming device to proceed to decision diamond 2006, where a determination is made of whether a pre-reveal is awarded. When it is determined that no pre-reveal is included in the game session ticket, the method proceeds to step 2022 where the game symbols are simply revealed to the player and the outcome of the game session is communicated through the gaming device display screen, such as shown in FIG. 8C. When it is determined that a pre-reveal is included in the game session ticket, the method proceeds to step 2008 where a screen shift occurs that results in the gaming device display showing a background pre-reveal display area, such as in FIG. 13A. The screen shift may be or include an animation, such as an entertaining animation relating to the game theme and symbols.

Upon completing the screen shift action, the method continues at step 2010 where one or more pre-reveal symbol is displayed in the background display area. In some embodiments, the pre-reveal symbol may include several new symbols, such as the pick-em symbols depicted in FIG. 13A.

In the pick-em example, the method proceeds to step 2012 where a player input is received that indicates a player selection of one or more of the pick-em symbols.

At step 2014, the selected pick-em symbol then performs an animation or transformation to reveal a pre-reveal symbol or game symbol in place of the pick-em symbol that is awarded to the player.

The method proceeds to decision diamond 2016, where the method branches depending upon whether the selected pick-em symbol reveals a pre-reveal symbol or not. When the revealed symbol is not a pre-reveal symbol, the method proceeds to step 2020 where another screen shift action is performed to shift the player view to the foreground display area.

When the revealed symbol is a pre-reveal symbol, the method proceeds to step 2018 where a pre-reveal action and/or animation occurs. In an illustrative example, the pre-reveal symbol is the wheel symbol 1306A from FIGS. 14B and 14C, and the pre-reveal animation performed is a wheel spin.

Whether the selected pick-em symbol reveals a pre-reveal symbol or not, the revealed symbol may ultimately result in a game symbol. For example, in FIG. 13B where the selected pick-em symbol reveals a yeti symbol, the yeti becomes a game symbol occupying a game symbol display position. For another example, in FIGS. 14B and 14C where the selected pick-em symbol reveals a pre-reveal wheel spin that results in a WILD 2X multiplier, the WILD 2X multiplier becomes a game symbol occupying a game symbol display position.

Upon completion of the pre-reveal symbol display, the method proceeds to step 2020 where another screen shift action is performed to shift the player's view back to the foreground display area.

Once the player's view is focused again on the foreground display area, all remaining unrevealed game symbols are revealed at step 2022. The revealed symbols and any win amount are consistent with the pre-reveal symbol displayed previously. In some embodiments, the pre-reveal symbol display included a reveal of one or more game symbols for display in the game symbol display positions in the foreground. In such embodiments, the game symbols are not revealed, but instead simply present when the screen shifts back to the foreground display area.

At step 2024, the method terminates after presenting and delivering to the player an award amount associated with the game session ticket.

While the term “pre-reveal” is used to describe symbols associated with the embedded feature gameplay, these symbols, their associated animations, and associated game play may also be referred to merely as “entertaining animations” building anticipation for a game session award.

The pull-tab games presented herein include an auto-close option that may be selected by the operator, for any game played at a particular venue. The auto-close option automatically replaces a finite game pool with a new pool when all prizes exceeding a predetermined value for the deck have been exhausted and the game may no longer be desirable by players. When the auto-close option is turned “ON,” a deck may automatically close and be replaced by a new deck when prizes over a game specific value set in the portal are gone. For example, a game may have 3 large value prizes and when the last prize is awarded, the deck may close and a new deck may open. By way of example and not of limitation, the auto close option is identified in the client game information when it is active, so players may know that it is active. A notification may also be given to all active clients when a new deck is open. This feature is attractive to players because they are always assured that there are always some valuable prizes remaining in a deck they may be playing.

The GLW 120 and MWS 102 systems are communicatively coupled to the VPS 104, which is communicatively coupled to the VPS video display as shown in FIG. 1. The VPS display provides the opportunity to highlight GLW players and the GLW events. The VPS display may be used to highlight regional standings, announce regional winners, show live or video clips of regional events, show live or video clips of the Tournament of Champions, show Interviews with PGL players, and other such GLW information. This close interaction between the VPS 104, MWS 102 and GLW 120 creates a social atmosphere, a spirit of competition, a sense of accomplishment, and improve the success of the wagering enterprise.

The illustrative gaming systems and methods presented above may include a plurality of server applications that configured to provide high-availability and redundancy, processes all inputs, generates outputs, and maintains a central database for accounting, game play, system configuration data, and other such data types. By way of example and not of limitation, critical system data regarding clients may be maintained a repository associated with the illustrative gaming system. Historical games results and leader board information may be maintained. Printable versions of this information may be available on the portal.

The illustrative client devices described in the illustrative embodiments are communicatively coupled to a gaming system database, which stores client device data. Additionally, the illustrative gaming system database is configured to be secure. Furthermore, the illustrative gaming system database manages the data that is received from client devices in geographically dispersed gaming venues.

The illustrative centralized gaming system may be disposed in a central site as described herein. The illustrative centralized gaming system may process information received over the internet backbone from client devices such as mobile devices, management terminals and other such client devices.

The illustrative MWS sub-system manages the funding of game play and operation of wagering games and overall system management. All gaming messaging between servers and client devices is sent and received over a secure internet network that directs network traffic to the appropriate server elements. A Portal service receives messages from management terminals and provides functionality to authorized users to control the system and access real-time and historical data. All server applications are structured to be deployable in a virtual server environment, configured for high availability with fail-over capabilities on hardware components and database structures that keep a multiplicity of all data records.

By way of example and not of limitation, the games supported by the wagering system include electronic pull-tabs, electronic pull-tab tournaments, embedded feature electronic pull-tabs, linked bingo, high-speed linked bingo with entertainment, bingo tournaments, slot games, video poker, multi-player poker, blackjack, roulette, and other casino or entertainment games.

Many game types, including electronic pull-tabs and the entertainment aspect of linked bingo have pre-reveal modes that award prizes based on a theme-specific animation. Often these features take more play time than a conventional game. While these features are entertaining, many players who have played the games for some period of time find the time spent in animation wasteful. Therefore, this system features a unique option at the beginning of any potentially long pre-reveal animation. The player is presented with a screen announcing the pre-reveal and then is presented with an option to proceed with the pre-reveal animation or bypass the animation and go directly to the prize award at the end of the animation.

It is clear that the infrastructure of the MWS with the added capabilities of the VPS can support a wide variety of game types, in addition to the ones described herein. Those games include slot machine games, video lottery games, poker, blackjack, skill-based wagering games, among others.

It should be noted that in jurisdictions that allow gaming outside of physically licensed areas some of the above-mentioned security considerations may be relaxed or replaced by more appropriate mechanisms.

It is to be understood that the detailed description of illustrative embodiments are provided for illustrative purposes. Thus, the degree of software modularity for the transactional system and method presented above may evolve to benefit from the improved performance and lower cost of the future hardware components that meet the system and method requirements presented. The scope of the claims is not limited to these specific embodiments or examples. Therefore, various process limitations, elements, details, and uses may differ from those just described, or be expanded on or implemented using technologies not yet commercially viable, and yet still be within the inventive concepts of the present disclosure. The scope of the invention is determined by the following claims and their legal equivalents.

What is claimed is:

1. A pull-tab gaming system comprising:
a network component that generates an electronic pull-tab deck including a plurality of electronic pull-tab tickets, in which each of the plurality of electronic pull-tab tickets is associated with a ticket value, a screen shift value, a foreground display area, and a background display area;
a plurality of game symbol display positions associated with the background display area;
a plurality of value symbol display positions associated with the foreground display area;
a gaming device communicatively coupled to the network component, wherein the gaming device includes a processor, a memory, and a display;
an electronic pull-tab ticket request generated by the gaming device that is communicated to the network component, which selects one electronic pull-tab ticket from the electronic pull-tab deck;
the gaming device receives the electronic pull-tab ticket from the network component and displays an image associated with the electronic pull-tab ticket at the background display area; and
the gaming device performs a screen shift action when the screen shift value associated with the electronic pull-tab ticket is a non-zero value, wherein the screen shift action corresponds to the non-zero screen shift value associated with the electronic pull-tab ticket, wherein the screen shift action further displays at least one value symbol in at least one value symbol display position.

2. The system of claim 1 wherein the gaming device performs a second screen shift action when the screen shift value associated with the electronic pull-tab ticket is the non-zero value, wherein the second screen shift action refocuses the gaming device display on the background display area having the image associated with the electronic pull-tab ticket value.

3. The system of claim 1 wherein the screen shift action includes one of a zoom-in action, a pan action, a rotate action, and any combination thereof.

4. The system of claim 1 wherein the network component awards the ticket value to a player account.

5. The system of claim 1 wherein the screen shift action includes an animation.

6. The system of claim 1 wherein the network component includes a centralized resource server and a deck generator server, wherein the centralized resource server selects the one electronic pull-tab ticket from the electronic pull-tab deck, and wherein the deck generator server generates the deck including the plurality of electronic pull-tab tickets.

7. A pull-tab gaming system comprising:
a network component that generates an electronic pull-tab deck including a plurality of electronic pull-tab tickets, in which each of the plurality of electronic pull-tab tickets is associated with a ticket value, a screen shift value, and a display area;
a plurality of game symbol display positions associated with the display area;
a gaming device communicatively coupled to the network component, wherein the gaming device includes a processor, a memory, and a display;
an electronic pull-tab ticket request generated by the gaming device that is communicated to the network component, which selects one electronic pull-tab ticket from the electronic pull-tab deck;
the gaming device receives the electronic pull-tab ticket from the network component and displays an image associated with the electronic pull-tab ticket at the display area; and
the gaming device performs a screen shift action when the screen shift value associated with the electronic pull-tab ticket is a non-zero value, wherein the screen shift action corresponds to the non-zero screen shift value associated with the electronic pull-tab ticket.

8. The system of claim 7 wherein the screen shift action includes one of a zoom-in action, a pan action, a rotate action, and any combination thereof.

9. The system of claim 7 wherein the network component awards the ticket value to a player account.

10. The system of claim 7 wherein the screen shift action includes an animation.

11. The system of claim 7 wherein the at least one game symbol includes a prize multiplier.

12. The system of claim 7 wherein the network component includes a centralized resource server and a deck generator server, wherein the centralized resource server selects the one electronic pull-tab ticket from the electronic pull-tab deck, and wherein the deck generator server generates the deck including the plurality of electronic pull-tab tickets.

13. A pull-tab gaming system comprising:
a network component that generates an electronic pull-tab deck including a plurality of electronic pull-tab tickets, in which each of the plurality of electronic pull-tab tickets is associated with a ticket value, a pre-reveal value, and a display area;
a plurality of game symbol display positions associated with the display area;
a gaming device communicatively coupled to the network component, wherein the gaming device includes a processor, a memory, and a display;
an electronic pull-tab ticket request generated by the gaming device that is communicated to the network component, which selects one electronic pull-tab ticket from the electronic pull-tab deck;
the gaming device receives the electronic pull-tab ticket from the network component and displays an image associated with the electronic pull-tab ticket at the display area; and
the gaming device performs a screen shift action when the screen shift value associated with the electronic pull-tab ticket is a non-zero value, wherein the screen shift action corresponds to the non-zero pre-reveal value associated with the electronic pull-tab ticket, wherein the screen shift action includes reveal of at least one game symbol.

14. The system of claim 13 wherein the screen shift action includes one of a zoom-in action, a pan action, a rotate action, and any combination thereof.

15. The system of claim 13 wherein the screen shift action includes revealing at least three game symbols.

16. The system of claim 13 wherein the network component awards the ticket value to a player account.

17. The system of claim 13 wherein the screen shift action includes an animation.

18. The system of claim 13 wherein the at least one game symbol includes a prize multiplier.

19. The system of claim 13 wherein the network component includes a centralized resource server and a deck generator server, wherein the centralized resource server selects the one electronic pull-tab ticket from the electronic pull-tab deck, and wherein the deck generator server generates the deck including the plurality of electronic pull-tab tickets.

20. A pull-tab gaming method comprising:
generating an electronic pull-tab deck, by a network component, that includes a plurality of electronic pull-tab tickets, in which each of the plurality of electronic pull-tab tickets includes a ticket value, a screen shift value, a foreground display area, and a background display area;
providing a plurality of game symbol display positions associated with the foreground display area;
providing a plurality of value symbol display positions associated with the background display area;
communicatively coupling a gaming device to the network component, wherein the gaming device includes a processor, a memory, and a display;
generating, by one of the plurality of gaming devices, an electronic pull-tab ticket request;
communicating, by the gaming device, the electronic pull-tab ticket request to the network component;
selecting, by the network component, one electronic pull-tab ticket having a non-zero screen shift value;
receiving, by the gaming device, the selected electronic pull-tab ticket having the non-zero screen shift value from the network component and displaying an image associated with the electronic pull-tab ticket at the foreground display area; and
receiving, by the gaming device, a game input that causes the gaming device to perform a screen shift action corresponding to the selected electronic pull-tab ticket frameshift value, wherein the screen shift action focuses the gaming device display on the background display area, wherein the screen shift action further displays at least one value symbol in at least one value symbol display position.

21. The method of claim 20 further comprising performing a second screen shift action that refocuses the gaming device display on the foreground display area having the image associated with the electronic pull-tab ticket value.

22. The method of claim 20 wherein the screen shift action includes one of a zoom-in action, a zoom-out action, a pan action, a rotate action, and any combination thereof.

23. The method of claim 20 further comprising awarding, by the network component, the ticket value to a player account.

24. The method of claim 20 wherein the screen shift action includes an animation.

25. The method of claim 20 wherein the at least one value symbol includes a prize multiplier.

26. The method of claim 20 further comprising receiving, by the gaming device, a second input, wherein the second input causes at least a second value symbol to be revealed.

27. The method of claim 13 further comprising:
selecting, by a centralized resource server associated with the network component, the one electronic pull-tab ticket having the non-zero frameshift value; and
generating, by a deck generator server associated with the network component, the deck including the plurality of electronic pull-tab tickets.
